(19) United States
(12) Patent Application Publication
(10) Pub. No.: US 2026/0268834 A1
(43) Pub. Date: Sep. 10, 2026

(54) PIXEL CIRCUIT, DISPLAY DEVICE INCLUDING THE PIXEL CIRCUIT AND ELECTRONIC DEVICE INCLUDING THE DISPLAY DEVICE

(71) Applicant: Samsung Display Co., Ltd., Yongin-si (KR)

(72) Inventors: Mukyung JEON, Yongin-si (KR); Jongsik SHIM, Yongin-si (KR); Ahyoung KIM, Yongin-si (KR); Il-Joo KIM, Yongin-si (KR); Seunghee LEE, Yongin-si (KR)

(73) Assignee: Samsung Display Co., Ltd., Yongin-si (KR)

(21) Appl. No.: 19/410,789

(22) Filed: Dec. 5, 2025

(30) Foreign Application Priority Data
Mar. 7, 2025 (KR) 10-2025-0029662

(51) Int. Cl. G09G 3/32

(52) U.S. Cl. CPC G09G 3/32; G09G 2300/043; G09G 2300/0819; G09G 2310/08; G09G 2320/0233; G09G 2330/021

(57) ABSTRACT

A pixel circuit may include first to seventh transistors, a first capacitor, a second capacitor, and a light emitting element. The second transistor may include a control electrode which receives a writing gate signal, a first electrode receives a data voltage, and a second electrode connected to a fourth node, the fifth transistor may include a control electrode receives a compensation gate signal, a first electrode connected to the fourth node, and a second electrode receives a reference voltage, the seventh transistor may include a control electrode receives a second initialization gate signal, a first electrode receives a second initialization voltage, and a second electrode connected to the fourth node, and a first capacitor may include a first electrode connected to the fourth node and a second electrode connected to a first node.

### CROSS-REFERENCE TO RELATED APPLICATION

This application is based on and claims priority under 35 U.S.C. § 119 to Korean Patent Application No. 10-2025-0029662, filed on Mar. 7, 2025 in the Korean Intellectual Property Office, the present disclosures of which are herein incorporated by reference in their entireties.

### BACKGROUND

### 1. Field

Embodiments of the present disclosure relate to a pixel circuit, a display device including the pixel circuit, and an electronic device including the display device.

### 2. Description of Related Art

A pixel circuit may include transistors, capacitors, and light emitting element. A driving transistor included in the pixel circuit may generate a driving current based on a data voltage and the light emitting element may emit light based on the driving current. A voltage of a control electrode of the driving transistor may increase due to a coupling of a holding capacitor connected to the driving transistor. As the voltage of the control electrode of the driving transistor increases, a threshold voltage of the driving transistor may not be sufficiently compensated in a threshold voltage compensation period. Accordingly, a compensation rate for the threshold voltage of the driving transistor may decrease. When the compensation rate for the threshold voltage of the driving transistor decreases, the driving transistor may not accurately generate the driving current corresponding to the data voltage. Accordingly, the pixel circuit may not emit light at a target luminance corresponding to the data voltage. Display quality of a display device including the pixel circuit may be decreased.

### SUMMARY

One or more example embodiments of the present disclosure provide a pixel circuit that may improve display quality of a display device by accurately emitting light at a target luminance.

One or more example embodiments of the present disclosure provide the display device including the pixel circuit.

One or more example embodiments of the present disclosure provide an electronic device including the display device.

However, objects of the present disclosure are not limited to the above objects, and may be variously extended without departing from the spirit and scope of the present disclosure.

According to an aspect of one or more example embodiments, a pixel circuit may include a first transistor including a control electrode connected to a first node, a first electrode connected to a second node, and a second electrode connected to a third node; a second transistor including a control electrode configured to receive a writing gate signal, a first electrode configured to receive a data voltage, and a second electrode connected to a fourth node; a third transistor including a control electrode configured to receive a compensation gate signal, a first electrode connected to the first node, and a second electrode connected to the third node; a fourth transistor including a control electrode configured to receive a first emission signal, a first electrode configured to receive a first driving voltage, and a second electrode connected to the second node; a fifth transistor including a control electrode configured to receive the compensation gate signal, a first electrode connected to the fourth node, and a second electrode configured to receive a reference voltage; a sixth transistor including a control electrode configured to receive a first initialization gate signal, a first electrode connected to the first node, and a second electrode configured to receive a first initialization voltage; a seventh transistor including a control electrode configured to receive a second initialization gate signal, a first electrode configured to receive a second initialization voltage, and a second electrode connected to the fourth node; a first capacitor including a first electrode connected to the fourth node and a second electrode connected to the first node; a second capacitor including a first electrode configured to receive the first driving voltage and a second electrode connected to the fourth node; and a light emitting element including an anode and a cathode configured to receive a second driving voltage.

According to an aspect of one or more example embodiments, a display device may include a display panel including a pixel circuit and a display panel driver configured to drive the display panel, and the pixel circuit may include a first transistor including a control electrode connected to a first node, a first electrode connected to a second node, and a second electrode connected to a third node; a second transistor including a control electrode configured to receive a writing gate signal, a first electrode configured to receive a data voltage, and a second electrode connected to a fourth node; a third transistor including a control electrode configured to receive a compensation gate signal, a first electrode connected to the first node, and a second electrode connected to the third node; a fourth transistor including a control electrode configured to receive a first emission signal, a first electrode configured to receive a first driving voltage, and a second electrode connected to the second node; a fifth transistor including a control electrode configured to receive the compensation gate signal, a first electrode connected to the fourth node, and a second electrode configured to receive a reference voltage; a sixth transistor including a control electrode configured to receive a first initialization gate signal, a first electrode connected to the first node, and a second electrode configured to receive a first initialization voltage; a seventh transistor including a control electrode configured to receive a second initialization gate signal, a first electrode configured to receive a second initialization voltage, and a second electrode connected to the fourth node; a first capacitor including a first electrode connected to the fourth node and a second electrode connected to the first node; a second capacitor including a first electrode configured to receive the first driving voltage and a second electrode connected to the fourth node; and a light emitting element including an anode and a cathode configured to receive a second driving voltage.

According to an aspect of one or more example embodiments, an electronic device may include a processor configured to generate an input control signal and input image data, a display panel including a pixel circuit, and a display panel driver configured to drive the display panel based on the input control signal and the input image data, and the pixel circuit may include a first transistor including a control electrode connected to a first node, a first electrode connected to a second node, and a second electrode connected to a third node; a second transistor including a control electrode configured to receive a writing gate signal, a first electrode configured to receive a data voltage, and a second electrode connected to a fourth node; a third transistor including a control electrode configured to receive a compensation gate signal, a first electrode connected to the first node, and a second electrode connected to the third node; a fourth transistor including a control electrode configured to receive a first emission signal, a first electrode configured to receive a first driving voltage, and a second electrode connected to the second node; a fifth transistor including a control electrode configured to receive the compensation gate signal, a first electrode connected to the fourth node, and a second electrode configured to receive a reference voltage; a sixth transistor including a control electrode configured to receive a first initialization gate signal, a first electrode connected to the first node, and a second electrode configured to receive a first initialization voltage; a seventh transistor including a control electrode configured to receive a second initialization gate signal, a first electrode configured to receive a second initialization voltage, and a second electrode connected to the fourth node; a first capacitor including a first electrode connected to the fourth node and a second electrode connected to the first node; a second capacitor including a first electrode configured to receive the first driving voltage and a second electrode connected to the fourth node; and a light emitting element including an anode and a cathode configured to receive a second driving voltage.

### BRIEF DESCRIPTION OF DRAWINGS

Illustrative, non-limiting embodiments will be more clearly understood from the following detailed description in conjunction with the accompanying drawings.

FIG. 1 is a block diagram illustrating a display device according to one or more embodiments.

FIG. 2 is a circuit diagram illustrating an embodiment of a pixel circuit included in a display panel of the display device of FIG. 1.

FIG. 3 is a timing diagram illustrating periods in which the pixel circuit of FIG. 2 operates.

FIG. 4A is a graph illustrating a voltage of a first node of a pixel circuit according to a comparative example.

FIG. 4B is a graph illustrating a voltage of a first node of the pixel circuit of FIG. 2.

FIG. 5 is a graph illustrating a driving current variation rate according to a threshold voltage variation amount of a first transistor in a low gray-level period.

FIG. 6 is a circuit diagram illustrating an embodiment of a pixel circuit included in a display panel of the display device of FIG. 1.

FIG. 7 is a circuit diagram illustrating an embodiment of a pixel circuit included in a display panel of the display device of FIG. 1.

FIG. 8 is a graph illustrating a voltage of a first node of the pixel circuit of FIG. 7.

FIG. 9 is a circuit diagram illustrating an embodiment of a pixel circuit included in a display panel of the display device of FIG. 1.

FIG. 10 is a timing diagram illustrating periods in which the pixel circuit of FIG. 9 operates.

FIG. 11 is a circuit diagram illustrating an embodiment of a pixel circuit included in a display panel of the display device of FIG. 1.

FIG. 12 is a circuit diagram illustrating an embodiment of a pixel circuit included in a display panel of the display device of FIG. 1.

FIG. 13 is a circuit diagram illustrating an embodiment of a pixel circuit included in a display panel of the display device of FIG. 1.

FIG. 14 is a timing diagram illustrating periods in which the pixel circuit of FIG. 13 operates.

FIG. 15 is a circuit diagram illustrating an embodiment of a pixel circuit included in a display panel of the display device of FIG. 1.

FIG. 16 is a block diagram illustrating an electronic device according to one or more embodiments.

FIG. 17 is a schematic diagram illustrating various examples of the electronic device of FIG. 1.

### DETAILED DESCRIPTION

Hereinafter, display devices in accordance with example embodiments will be described in more detail with reference to the accompanying drawings. The same reference numerals are used for the same components in the drawings, and redundant descriptions of the same components will be omitted.

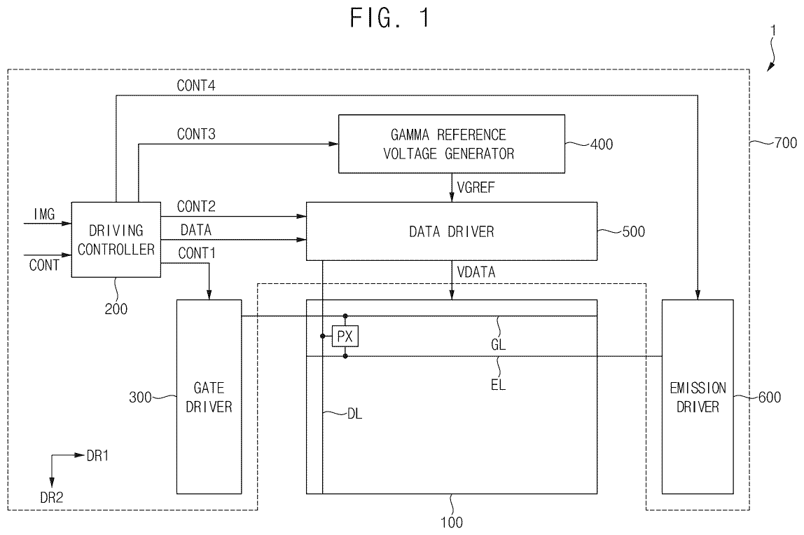

FIG. 1 is a block diagram illustrating a display device 1 according to one or more embodiments.

Referring to FIG. 1, the display device 1 may include a display panel 100 and a display panel driver 700. The display panel driver 700 may include a driving controller 200, a gate driver 300, a gamma reference voltage generator 400, a data driver 500, and an emission driver 600.

For example, the driving controller 200 and the data driver 500 may be integrated into a single chip. For example, the driving controller 200, the gamma reference voltage generator 400, and the data driver 500 may be integrated into a single chip. A driving module including at least the driving controller 200 and the data driver 500 which are integrated into the single chip may be referred to as a timing controller embedded data driver (TED).

The display panel 100 may include a display region on which an image is displayed and a peripheral region adjacent to the display region. For example, the peripheral region may be referred to as a bezel.

The display panel 100 may include gate lines GL, data lines DL, emission lines EL and pixel circuits PX. For example, the gate lines GL may extend in a first direction DR1 and the emission lines EL may extend in the first direction DR1. The data lines DL may extend in a second direction DR2 crossing the first direction DR1.

The driving controller 200 may receive input image data IMG and an input control signal CONT from an external device. For example, the input image data IMG may include red image data, green image data, and blue image data. In some embodiments, the input image data IMG may further include white image data. In another example, the input image data IMG may include magenta image data, yellow image data, and cyan image data. The input control signal CONT may include a master clock signal and a data enable signal. The input control signal CONT may further include a vertical synchronizing signal and a horizontal synchronizing signal.

The driving controller 200 may generate a gate control signal CONT1, a data control signal CONT2, a gamma control signal CONT3, an emission control signal CONT4, and a data signal DATA based on the input image data IMG and the input control signal CONT.

The driving controller 200 may generate the gate control signal CONT1 for controlling an operation of the gate driver 300 based on the input control signal CONT, and may output the gate control signal CONT1 to the gate driver 300. The gate control signal CONT1 may include a vertical gate start signal and a gate clock signal.

The driving controller 200 may generate the data control signal CONT2 for controlling an operation of the data driver 500 based on the input control signal CONT, and may output the data control signal CONT2 to the data driver 500. The data control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the gamma control signal CONT3 for controlling an operation of the gamma reference voltage generator 400 based on the input control signal CONT, and may output the gamma control signal CONT3 to the gamma reference voltage generator 400.

The driving controller 200 may generate the emission control signal CONT4 for controlling an operation of the emission driver 600 based on the input control signal CONT, and may output the emission control signal CONT4 to the emission driver 600. The emission control signal CONT4 may include a vertical emission start signal and an emission clock signal.

The gate driver 300 may generate gate signals transmitted to the pixel circuits PX through the gate lines GL in response to the gate control signal CONT1 received from the driving controller 200. The gate driver 300 may output the gate signals to the gate lines GL. For example, the gate signals may include a writing gate signal, a compensation gate signal, a first initialization gate signal, a second initialization gate signal, and a bias gate signal.

In an embodiment, the gate driver 300 may be integrated on the peripheral region of the display panel 100. In an embodiment, the gate driver 300 may be mounted on the peripheral region of the display panel 100.

The gamma reference voltage generator 400 may generate a gamma reference voltage VGREF in response to the gamma control signal CONT3 received from the driving controller 200. The gamma reference voltage generator 400 may output the gamma reference voltage VGREF to the data driver 500.

In an embodiment, the gamma reference voltage generator 400 may be disposed in the driving controller 200, or in the data driver 500.

The data driver 500 may receive the data control signal CONT2 and the data signal DATA from the driving controller 200, and may receive the gamma reference voltages VGREF from the gamma reference voltage generator 400. The data driver 500 may convert the data signal DATA having a digital form into data voltages having an analog form using the gamma reference voltages VGREF. The data driver 500 may output the data voltages to the data lines DL.

In an embodiment, the data driver 500 may be integrated on the peripheral region of the display panel 100. In an embodiment, the data driver 500 may be mounted on the peripheral region of the display panel 100.

The emission driver 600 may generate emission signals transmitted to the pixel circuits PX through the emission lines EL in response to the emission control signal CONT4 received from the driving controller 200. The emission driver 600 may output the emission signals to the emission lines EL. For example, the emission signals may include a first emission signal and a second emission signal.

In an embodiment, the emission driver 600 may be integrated on the peripheral region of the display panel 100. In an embodiment, the emission driver 600 may be mounted on the peripheral region of the display panel 100.

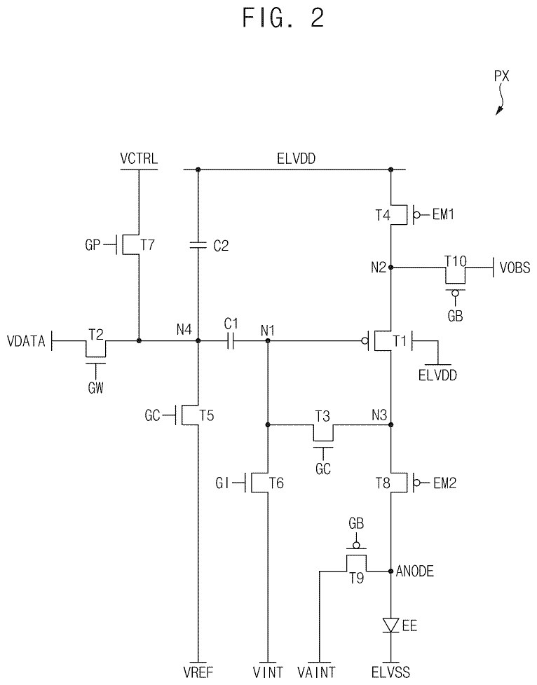

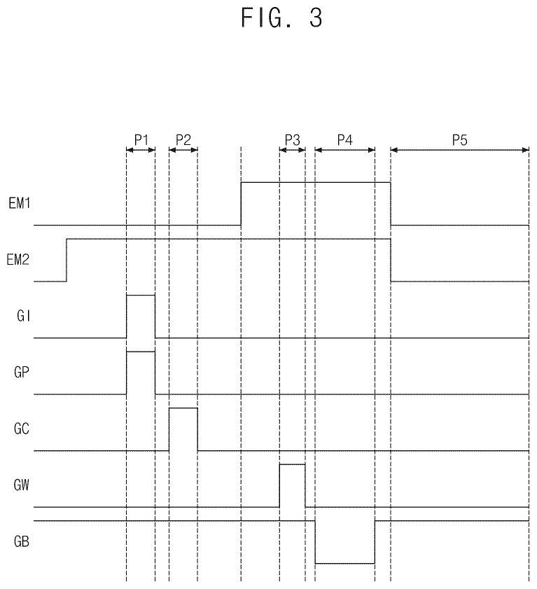

FIG. 2 is a circuit diagram illustrating an embodiment of the pixel circuit PX included in the display panel 100 of the display device 1 of FIG. 1. FIG. 3 is a timing diagram illustrating periods in which the pixel circuit PX of FIG. 2 operates.

Referring to FIG. 2, the pixel circuit PX may include first to seventh transistors T1 to T7, a first capacitor C1, a second capacitor C2, and a light emitting element EE. In some embodiments, the pixel circuit PX may further include eight to tenth transistors T8 to T10.

The first transistor T1 may include a control electrode connected to a first node N1, a first electrode connected to a second node N2, and a second electrode connected to a third node N3. The first transistor T1 may generate a driving current based on the data voltage VDATA. The first transistor T1 may be referred to as a driving transistor.

The second transistor T2 may include a control electrode which receives the writing gate signal GW, a first electrode which receives the data voltage VDATA, and a second electrode connected to a fourth node N4.

The third transistor T3 may include a control electrode which receives the compensation gate signal GC, a first electrode connected to the first node N1, and a second electrode connected to the third node N3.

The fourth transistor T4 may include a control electrode which receives the first emission signal EM1, a first electrode which receives a first driving voltage ELVDD, and a second electrode connected to the second node N2.

The fifth transistor T5 may include a control electrode which receives the compensation gate signal GC, a first electrode connected to the fourth node N4, and a second electrode which receives a reference voltage VREF.

The sixth transistor T6 may include a control electrode which receives the first initialization gate signal GI, a first electrode connected to the first node N1, and a second electrode which receives a first initialization voltage VINT.

The seventh transistor T7 may include a control electrode which receives the second initialization gate signal GP, a first electrode which receives a second initialization voltage VCTRL, and a second electrode connected to the fourth node N4.

In an embodiment, a magnitude of the second initialization voltage VCTRL may be greater than a magnitude of the first driving voltage ELVDD.

The eighth transistor T8 may include a control electrode which receives the second emission signal EM2, a first electrode connected to the third node N3, and a second electrode connected to an anode ANODE of the light emitting element EE.

The ninth transistor T9 may include a control electrode which receives the bias gate signal GB, a first electrode which receives an anode initialization voltage VAINT, and a second electrode connected to the anode ANODE of the light emitting element EE.

The tenth transistor T10 may include a control electrode which receives the bias gate signal GB, a first electrode connected to the second node N2, and a second electrode which receives a bias voltage VOBS.

The first capacitor C1 may include a first electrode connected to the fourth node N4 and a second electrode connected to the first node N1. The first capacitor C1 may be referred to as a holding capacitor.

The second capacitor C2 may include a first electrode which receives the first driving voltage ELVDD and a second electrode connected to the fourth node N4. The second capacitor C2 may be referred to as a storage capacitor.

The light emitting element EE may include the anode ANODE and a cathode which receives a second driving voltage ELVSS. The light emitting element EE may emit light based on the driving current generated by the first transistor T1.

In an embodiment, the first driving voltage ELVDD may be greater than the reference voltage VREF and the second initialization voltage VCTRL may be greater than the first driving voltage ELVDD. That is, a voltage level of the first driving voltage ELVDD may be higher than a voltage level of the reference voltage VREF and a voltage level of the second initialization voltage VCTRL may be higher than the voltage level of the first driving voltage ELVDD.

In an embodiment, the first driving voltage ELVDD may be greater than the reference voltage VREF and the second initialization voltage VCTRL may be the first driving voltage ELVDD. That is, the voltage level of the first driving voltage ELVDD may be higher than the voltage level of the reference voltage VREF and the voltage level of the second initialization voltage VCTRL may be equal to the voltage level of the first driving voltage ELVDD.

In an embodiment, the second initialization voltage VCTRL may be greater than the reference voltage VREF and the first driving voltage ELVDD may be greater than the reference voltage. That is, the voltage level of the second initialization voltage VCTRL may be higher than the voltage level of the reference voltage VREF and the voltage level of the first driving voltage ELVDD may be higher than the voltage level of the reference voltage VREF.

In an embodiment, each of the first transistor T1, the fourth transistor T4, the eighth transistor T8, the ninth transistor T9, and the tenth transistor T10 may be implemented as a P-channel metal oxide semiconductor (PMOS) transistor. For example, each of the first transistor T1, the fourth transistor T4, the eighth transistor T8, the ninth transistor T9, and the tenth transistor T10 may be implemented as a low temperature polysilicon (LTPS) transistor. For example, each of the first transistor T1, the fourth transistor T4, the eighth transistor T8, the ninth transistor T9, and the tenth transistor T10 may be implemented as a LTPS thin film transistor. Each of the second transistor T2, the third transistor T3, the fifth transistor T5, the sixth transistor T6, and the seventh transistor T7 may be implemented as an N-channel metal oxide semiconductor (NMOS) transistor. For example, each of the second transistor T2, the third transistor T3, the fifth transistor T5, the sixth transistor T6, and the seventh transistor T7 may be implemented as an oxide transistor. For example, each of the second transistor T2, the third transistor T3, the fifth transistor T5, the sixth transistor T6, and the seventh transistor T7 may be implemented as an oxide thin film transistor. However, the above are merely examples and the present disclosure is not limited thereto.

When each of the first transistor T1, the fourth transistor T4, and the eighth transistor T8 is implemented as the PMOS transistor, the driving current may be stably flow through the first transistor T1, the fourth transistor T4, and the eighth transistor T8. Accordingly, stability and reliability of the pixel circuit PX may be improved.

When each of the second transistor T2, the third transistor T3, the fifth transistor T5, the sixth transistor T6, and the seventh transistor T7 is implemented as the oxide transistor, a leakage current of each of the second transistor T2, the third transistor T3, the fifth transistor T5, the sixth transistor T6, and the seventh transistor T7 may decrease.

In an embodiment, the first transistor T1 may further include a second control electrode which receives the first driving voltage ELVDD. The first transistor T1 may further include the second control electrode which receives the first driving voltage ELVDD, such that a shift of a threshold voltage of the first transistor T1 may be prevented.

In an embodiment, each of the second transistor T2, the third transistor T3, the fifth transistor T5, the sixth transistor T6, and the seventh transistor T7 may further include a second control electrode.

The second control electrode of the second transistor T2 may be connected to the control electrode of the second transistor T2. The second control electrode of the second transistor T2 may be connected to the control electrode of the second transistor T2, such that a shift of a threshold voltage of the second transistor T2 may be prevented.

The second control electrode of the third transistor T3 may be connected to the control electrode of the third transistor T3. The second control electrode of the third transistor T3 may be connected to the control electrode of the third transistor T3, such that a shift of a threshold voltage of the third transistor T3 may be prevented.

The second control electrode of the fifth transistor T5 may be connected to the control electrode of the fifth transistor T5. The second control electrode of the fifth transistor T5 may be connected to the control electrode of the fifth transistor T5, such that a shift of a threshold voltage of the fifth transistor T5 may be prevented.

The second control electrode of the sixth transistor T6 may be connected to the control electrode of the sixth transistor T6. The second control electrode of the sixth transistor T6 may be connected to the control electrode of the sixth transistor T6, such that a shift of a threshold voltage of the sixth transistor T6 may be prevented.

The second control electrode of the seventh transistor T7 may be connected to the control electrode of the seventh transistor T7. The second control electrode of the seventh transistor T7 may be connected to the control electrode of the seventh transistor T7, such that a shift of a threshold voltage of the seventh transistor T7 may be prevented.

Referring to FIG. 3, periods in which the pixel circuit PX operates may include first to fifth periods P1 to P5. The first period P1 may be referred to as a first initialization period, the second period P2 may be referred to as a threshold voltage compensation period, the third period P3 may be referred to as a data writing period, a fourth period P4 may be referred to as a second initialization period, and the fifth period P5 may be referred to as an emission period.

In the first period P1, the first emission signal EM1 may have an activation level (e.g., a low level) and the second emission signal EM2 may have a deactivation level (e.g., a high level). In the first period P1, the first initialization gate signal GI may have an activation level (e.g., a high level) and the second initialization gate signal GP may have an activation level (e.g., a high level). In the first period P1, the compensation gate signal GC may have a deactivation level (e.g., a low level) and the writing gate signal GW may have a deactivation level (e.g., a low level). In addition, in the first period P1, the bias gate signal GB may have a deactivation level (e.g., a high level).

In the first period P1, the second transistor T2 may be turned off in response to the writing gate signal GW having the deactivation level and the third transistor T3 may be turned off in response to the compensation gate signal GC having the deactivation level. In the first period P1, the fourth transistor T4 may be turned on in response to the first emission signal EM1 having the activation level and the fifth transistor T5 may be turned off in response to the compensation gate signal GC having the deactivation level. In the first period P1, the sixth transistor T6 may be turned on in response to the first initialization gate signal GI having the activation level and the seventh transistor T7 may be turned on in response to the second initialization gate signal GP having the activation level. In the first period P1, the eighth transistor T8 may be turned off in response to the second emission signal EM2 having the deactivation level and the ninth transistor T9 may be turned off in response to the bias gate signal GB having the deactivation level. In addition, in the first period P1, the tenth transistor T10 may be turned off in response to the bias gate signal GB having the deactivation level.

The sixth transistor T6, which is turned on, may transmit the first initialization voltage VINT to the first node N1. The first node N1 may be initialized to the first initialization voltage VINT.

The seventh transistor T7, which is turned on, may transmit the second initialization voltage VCTRL to the fourth node N4. The fourth node N4 may be initialized to the second initialization voltage VCTRL.

The fourth transistor T4, which is turned on, may transmit the first driving voltage ELVDD to the second node N2. The second node N2 may have the first driving voltage ELVDD.

In the second period P2, the first emission signal EM1 may have the activation level and the second emission signal EM2 may have the deactivation level. In the second period P2, the first initialization gate signal GI may have a deactivation level (e.g., a low level) and the second initialization gate signal GP may have a deactivation level (e.g., a low level). In the second period P2, the compensation gate signal GC may have an activation level (e.g., a high level) and the writing gate signal GW may have the deactivation level. In addition, in the second period P2, the bias gate signal GB may have the deactivation level.

In the second period P2, the second transistor T2 may be turned off in response to the writing gate signal GW having the deactivation level and the third transistor T3 may be turned on in response to the compensation gate signal GC having the activation level. In the second period P2, the fourth transistor T4 may be turned on in response to the first emission signal EM1 having the activation level and the fifth transistor T5 may be turned on in response to the compensation gate signal GC having the activation level. In the second period P2, the sixth transistor T6 may be turned off in response to the first initialization gate signal GI having the deactivation level and the seventh transistor T7 may be turned off in response to the second initialization gate signal GP having the deactivation level. In the second period P2, the eighth transistor T8 may be turned off in response to the second emission signal EM2 having the deactivation level and the ninth transistor T9 may be turned off in response to the bias gate signal GB having the deactivation level. In addition, in the second period P2, the tenth transistor T10 may be turned off in response to the bias gate signal GB having the deactivation level.

The second node N2 may have the first driving voltage ELVDD and the first node N1 may have the first initialization voltage VINT, such that a difference between a voltage of the second node N2 and a voltage of the first node N1 may be greater than the threshold voltage of the first transistor T1. Accordingly, the first transistor T1 may be turned on.

A voltage of the third node N3 may be increased by the first transistor T1 which is turned on. In addition, the third transistor T3, which is turned on, may diode-connect the first node N1 and the third node N3. Accordingly, when the voltage of the third node N3 increases, the voltage of the first node N1 may increase.

When the difference between the voltage of the second node N2 and the voltage of the first node N1 is equal to the threshold voltage of the first transistor T1, the first transistor T1 may be turned off. The threshold voltage of the first transistor T1 may be compensated for.

The fifth transistor T5, which is turned on, may transmit the reference voltage VREF to the fourth node N4. The fourth node N4 may have the reference voltage VREF.

In the third period P3, the first emission signal EM1 may have a deactivation level (e.g., a high level) and the second emission signal EM2 may have the deactivation level. In the third period P3, the first initialization gate signal GI may have the deactivation level and the second initialization gate signal GP may have the deactivation level. In the third period P3, the compensation gate signal GC may have the deactivation level and the writing gate signal GW may have an activation level (e.g., a high level). In addition, in the third period P3, the bias gate signal GB may have the deactivation level.

In the third period P3, the second transistor T2 may be turned on in response to the writing gate signal GW having the activation level and the third transistor T3 may be turned off in response to the compensation gate signal GC having the deactivation level. In the third period P3, the fourth transistor T4 may be turned off in response to the first emission signal EM1 having the deactivation level and the fifth transistor T5 may be turned off in response to the compensation gate signal GC having the deactivation level. In the third period P3, the sixth transistor T6 may be turned off in response to the first initialization gate signal GI having the deactivation level and the seventh transistor T7 may be turned off in response to the second initialization gate signal GP having the deactivation level. In the third period P3, the eighth transistor T8 may be turned off in response to the second emission signal EM2 having the deactivation level and the ninth transistor T9 may be turned off in response to the bias gate signal GB having the deactivation level. In addition, in the third period P3, the tenth transistor T10 may be turned off in response to the bias gate signal GB having the deactivation level.

The second transistor T2, which is turned on, may transmit the data voltage VDATA to the fourth node N4. The fourth node N4 may have the data voltage VDATA.

In the fourth period P4, the first emission signal EM1 may have the deactivation level and the second emission signal EM2 may have the deactivation level. In the fourth period P4, the first initialization gate signal GI may have the deactivation level and the second initialization gate signal GP may have the deactivation level. In the fourth period P4, the compensation gate signal GC may have the deactivation level and the writing gate signal GW may have the deactivation level. In addition, in the fourth period P4, the bias gate signal GB may have an activation level (e.g., a low level).

In the fourth period P4, the second transistor T2 may be turned off in response to the writing gate signal GW having the deactivation level and the third transistor T3 may be turned off in response to the compensation gate signal GC having the deactivation level. In the fourth period P4, the fourth transistor T4 may be turned off in response to the first emission signal EM1 having the deactivation level and the fifth transistor T5 may be turned off in response to the compensation gate signal GC having the deactivation level. In the fourth period P4, the sixth transistor T6 may be turned off in response to the first initialization gate signal GI having the deactivation level and the seventh transistor T7 may be turned off in response to the second initialization gate signal GP having the deactivation level. In the fourth period P4, the eighth transistor T8 may be turned off in response to the second emission signal EM2 having the deactivation level and the ninth transistor T9 may be turned on in response to the bias gate signal GB having the activation level. In addition, in the fourth period P4, the tenth transistor T10 may be turned on in response to the bias gate signal GB having the activation level.

The ninth transistor T9, which is turned on, may transmit the anode initialization voltage VAINT to the anode ANODE of the light emitting element EE. The anode ANODE of the light emitting element EE may be initialized to the anode initialization voltage VAINT.

The anode ANODE of the light emitting element EE may be initialized to the anode initialization voltage VAINT, such that the light emitting element may not emit light regardless of a leakage current of the first transistor T1. That is, the light emitting element EE may accurately emit light at a black gray-level. Accordingly, a black characteristic of the pixel circuit PX may be improved.

The tenth transistor T10, which is turned on, may transmit the bias voltage VOBS to the second node N2. The second node N2 may have the bias voltage VOBS. The bias voltage VOBS may be transmitted to the second node N2, such that a hysteresis characteristic of the pixel circuit PX may be improved.

In the fifth period P5, the first emission signal EM1 may have the activation level and the second emission signal EM2 may have an activation level (e.g., a low level). In the fifth period P5, the first initialization gate signal GI may have the deactivation level and the second initialization gate signal GP may have the deactivation level. In the fifth period P5, the compensation gate signal GC may have the deactivation level and the writing gate signal GW may have the deactivation level. In addition, in the fifth period P5, the bias gate signal GB may have the deactivation level.

In the fifth period P5, the second transistor T2 may be turned off in response to the writing gate signal GW having the deactivation level and the third transistor T3 may be turned off in response to the compensation gate signal GC having the deactivation level. In the fifth period P5, the fourth transistor T4 may be turned on in response to the first emission signal EM1 having the activation level and the fifth transistor T5 may be turned off in response to the compensation gate signal GC having the deactivation level. In the fourth period P5, the sixth transistor T6 may be turned off in response to the first initialization gate signal GI having the deactivation level and the seventh transistor T7 may be turned off in response to the second initialization gate signal GP having the deactivation level. In the fourth period P5, the eighth transistor T8 may be turned on in response to the second emission signal EM2 having the activation level and the ninth transistor T9 may be turned off in response to the bias gate signal GB having the deactivation level. In addition, in the fourth period P5, the tenth transistor T10 may be turned off in response to the bias gate signal GB having the deactivation level.

The fourth transistor T4, which is turned on, may transmit the first driving voltage ELVDD to the second node N2. The second node N2 may have the first driving voltage ELVDD. The second node N2 may have the first driving voltage ELVDD, such that the difference between the voltage of the second node N2 and the voltage of the first node N1 may be greater than the threshold voltage of the first transistor T1. Accordingly, the first transistor T1 may be turned on. The first transistor T1, which is turned on, may generate the driving current corresponding to the data voltage VDATA. The eighth transistor T8, which is turned on, may transmit the driving current, which is generated by the first transistor T1, to the light emitting element EE. The light emitting element EE may emit light at a luminance corresponding to the data voltage VDATA by the driving current.

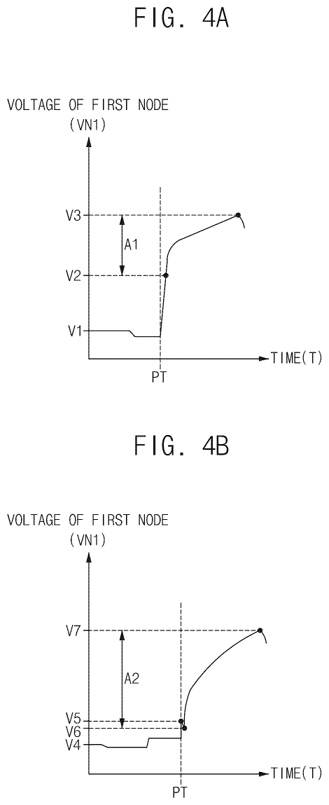

FIG. 4A is a graph illustrating a voltage of a first node of a related art pixel circuit according to a comparative example. FIG. 4B is a graph illustrating the voltage of the first node N1 of the pixel circuit PX of FIG. 2.

A compensation point PT is a point at which a level of the compensation gate signal GC changes from the deactivation level to the activation level. For example, the compensation point PT is a point at which the level of the compensation gate signal GC changes from the low level to the high level.

A compensation rate for the threshold voltage of the first transistor T1 may be calculated by [Equation], “CR=ΔVGS/ΔVTH”, where CR denotes the compensation rate, ΔVGS denotes the difference between a voltage VN1 of the first node N1 and the voltage of the second node N2, and ΔVTH denotes a threshold voltage variation amount of the first transistor T1.

The voltage of the second node N2 may be constant at the first driving voltage ELVDD, and thus, the compensation rate may be changed according to a variation amount of the voltage VN1 of the first node N1. As the variation amount of the voltage VN1 of the first node N1 increases, the compensation rate may increase.

The related art conventional pixel circuit according to the comparative example may be similar to the pixel circuit PX of FIG. 2 except that the related art pixel circuit does not include the seventh transistor T7.

Referring to FIG. 4A, a period before the compensation point PT may be the first period P1. That is, the period before the compensation point PT may be the first initialization period. A period after the compensation point PT may be the second period P2. That is, the period after the compensation point PT may be the threshold voltage compensation period.

In the period before the compensation point PT, the voltage VN1 of the first node N1 of the related art pixel circuit may be a first voltage V1. For example, the first voltage V1 may be the first initialization voltage VINT and the first initialization voltage VINT may be about −3.2V.

When the level of the compensation gate signal GC changes from the deactivation level to the activation level at the compensation point PT, the voltage VN1 of the first node N1 of the related art pixel circuit may be momentarily increased. A voltage of the fourth node N4 of the related art pixel circuit may be less than the reference voltage VREF.

The fifth transistor T5 of the related art pixel circuit may be turned on in response to the compensation gate signal GC having the activation level and the fifth transistor T5, which is turned on, may transmit the reference voltage VREF to the fourth node N4 of the related art pixel circuit. The voltage of the fourth node N4 of the related art pixel circuit may be increased to the reference voltage VREF. The voltage of the fourth node N4 of the related art pixel circuit may be increased to the reference voltage VREF, such that the voltage VN1 of the first node N1 of the related art pixel circuit may be further increased to a second voltage V2 by a coupling of the first capacitor C1 of the related art pixel circuit.

After the voltage VN1 of the first node N1 of the related art pixel circuit is further increased to the second voltage V2 by the coupling of the first capacitor C1 of the related art pixel circuit, the threshold voltage of the first transistor T1 of the related art pixel circuit may be compensated by the third transistor T3 of the related art pixel circuit. The threshold voltage of the first transistor T1 of the related art pixel circuit may be compensated, such that the voltage VN1 of the first node N1 of the related art pixel circuit may be increased from the second voltage V2 to a third voltage V3. The variation amount of the voltage VN1 of the first node N1 of the related art pixel circuit due to a threshold voltage compensation operation for the first transistor T1 of the related art pixel circuit may be a first compensation value A1. For example, when the variation amount of the voltage VN1 of the first node N1 of the related art pixel circuit is the first compensation value A1, the compensation rate for the threshold voltage of the first transistor T1 of the related art pixel circuit may be about 96%.

Referring to FIG. 4B, the period before the compensation point PT may be the first period P1. That is, the period before the compensation point PT may be the first initialization period. The period after the compensation point PT may be the second period P2. That is, the period after the compensation point PT may be the threshold voltage compensation period.

In the period before the compensation point PT, the voltage VN1 of the first node N1 of the pixel circuit PX may be a fourth voltage V4. For example, the fourth voltage V4 may be the first initialization voltage VINT and the first initialization voltage VINT may be about −3.2V.

In the period before the compensation period, the second initialization gate signal GP may have the activation level, such that the seventh transistor T7 of the pixel circuit PX may be turned on and the seventh transistor T7, which is turned on, may transmit the second initialization voltage VCTRL to the fourth node N4 of the pixel circuit PX. For example, the second initialization voltage VCTRL may be the first driving voltage ELVDD. For example, the voltage level of the second initialization voltage VCTRL may be higher than the voltage level of the first driving voltage ELVDD. In the period after the compensation point PT, the fourth node N4 of the pixel circuit PX may have the second initialization voltage VCTRL. The second initialization voltage VCTRL may be greater than the reference voltage VREF. That is, the voltage level of the second initialization voltage VCTRL may be higher than the voltage level of the reference voltage VREF. For example, the voltage level of the first driving voltage ELVDD may be higher than the voltage level of the reference voltage VREF and the voltage level of the second initialization voltage VCTRL may be higher than the voltage level of the first driving voltage ELVDD. For example, the voltage level of the first driving voltage ELVDD may be higher than the voltage level of the reference voltage VREF and the voltage level of the second initialization voltage VCTRL may be equal to the voltage level of the first driving voltage ELVDD.

When the level of the compensation gate signal GC changes from the deactivation level to the activation level at the compensation point PT, the voltage VN1 of the first node N1 of the pixel circuit PX may be momentarily increased to a fifth voltage V5.

The fifth transistor T5 of the pixel circuit PX may be turned on in response to the compensation gate signal GC having the activation level and the fifth transistor T5, which is turned on, may transmit the reference voltage VREF to the fourth node N4. The voltage of the fourth node N4 of the pixel circuit PX may decrease from the second initialization voltage VCTRL to the reference voltage VREF. The voltage of the fourth node N4 of the pixel circuit PX may decrease to the reference voltage VREF, such that the voltage VN1 of the first node N1 of the pixel circuit PX may be decreased by the coupling of the first capacitor C1 of the pixel circuit PX. That is, the voltage VN1 of the first node N1 of the pixel circuit PX may be decreased from the fifth voltage V5 to a sixth voltage V6.

After the voltage VN1 of the first node N1 of the pixel circuit PX decreases to the sixth voltage V6 by the coupling of the first capacitor C1 of the pixel circuit PX, the threshold voltage of the first transistor T1 of the pixel circuit PX may be compensated by the third transistor T3 of the pixel circuit PX. The threshold voltage of the first transistor T1 of the pixel circuit PX may be compensated, such that the voltage VN1 of the first node N1 of the pixel circuit PX may be increased from the sixth voltage V6 to a seventh voltage V7. The variation amount of the voltage VN1 of the first node N1 of the pixel circuit PX due to the threshold voltage compensation operation for the first transistor T1 of the pixel circuit PX may be a second compensation value A2. The second compensation value A2 may be greater than the first compensation value A1. For example, when the variation amount of the voltage VN1 of the first node N1 is the second compensation value A2, the compensation rate for the threshold voltage of the first transistor T1 of the pixel circuit PX may be about 98.3%.

For example, as the second initialization voltage VCTRL increases, the variation amount of the voltage VN1 of the first node N1 may increase. That is, as the voltage level of the second initialization voltage VCTRL is higher, the variation amount of the voltage VN1 of the first node N1 may increase. The variation amount of the voltage VN1 of the first node N1 may increase, such that the compensation rate may increase as the second initialization voltage VCTRL increases.

When the fourth node N4 is initialized to the second initialization voltage VCTRL, which is greater than the reference voltage VREF, by the seventh transistor T7, which is turned on, in the first period P1, the compensation rate for the threshold voltage of the first transistor T1 of the pixel circuit PX may be greater than the compensation rate for the threshold voltage of the first transistor T1 of the related art pixel circuit. That is, the compensation rate of the pixel circuit PX may increase. The compensation rate of the pixel circuit PX may increase, such that the first transistor T1 of the pixel circuit PX may accurately generate the driving current corresponding to the data voltage VDATA. When the first transistor T1 of the pixel circuit PX accurately generates the driving current corresponding to the data voltage VDATA, the pixel circuit PX may accurately emit light at a target luminance. When the pixel circuit PX accurately emits light at the target luminance, display quality of the display device 1 may be improved.

In addition, the first initialization gate signal GI of the related art pixel circuit may toggle twice in a signal frame for decreasing a luminance deviation. In addition, the compensation gate signal GC of the related art pixel circuit may toggle twice in the signal frame for decreasing the luminance deviation. On the other hand, the first initialization gate signal GI of the pixel circuit PX according to an embodiment may toggle once in the signal frame for decreasing the luminance deviation. In addition, the compensation gate signal GC of the pixel circuit PX may toggle once in the signal frame for decreasing the luminance deviation. When the first initialization gate signal GI of the pixel circuit PX toggles once and the compensation gate signal GC of the pixel circuit PX toggles once in the signal frame, power consumption of the display device 1 including the pixel circuit PX may be less than power consumption of a display device including the related art pixel circuit. That is, the power consumption of the display device 1 including the pixel circuit PX may be reduced.

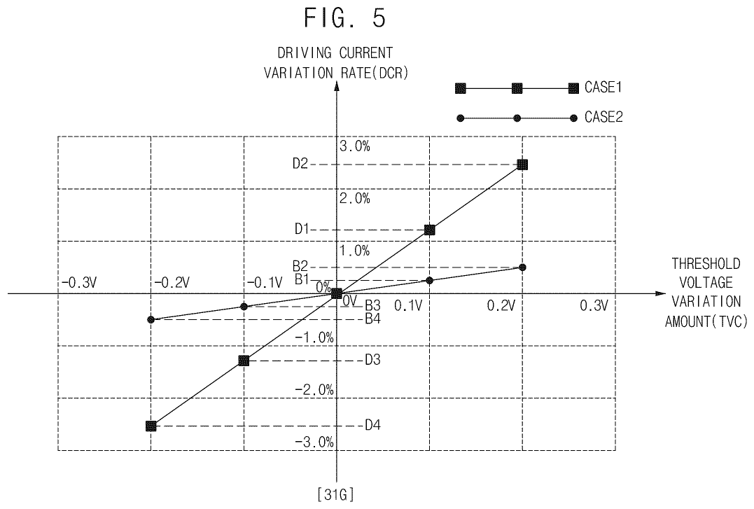

FIG. 5 is a graph illustrating a driving current variation rate DCR according to the threshold voltage variation amount TVC of the first transistor T1 in a low gray-level period.

Referring to FIG. 5, the driving current variation rate DCR may be changed according to the threshold voltage variation amount TVC of the first transistor T1. In an embodiment, a gray-level of the low gray-level period may be a 31-gray-level.

The threshold voltage variation amount TVC indicates a variation amount of the threshold voltage of the first transistor T1. The driving current variation rate DCR indicates a variation rate of the driving current generated by the first transistor T1 in the fifth period P5.

In a first case CASE1, the driving current variation rate DCR of the related art pixel circuit may be changed according to the threshold voltage variation amount TVC of the first transistor T1.

In a second case CASE2, the driving current variation rate DCR of the pixel circuit PX according to an embodiment may be changed according to the threshold voltage variation amount TVC of the first transistor T1.

When the threshold voltage variation amount TVC of the first transistor T1 is about 0.1V, the driving current variation rate DCR of the related art pixel circuit may be a first variation rate D1 and the driving current variation rate DCR of the pixel circuit PX may be a second variation rate B1. A magnitude of the second variation rate B1 may be less than a magnitude of the first variation rate D1. For example, the first variation rate D1 may be about 1.23% and the second variation rate B1 may be about 0.30%.

When the threshold voltage variation amount TVC of the first transistor T1 is about 0.2V, the driving current variation rate DCR of the related art pixel circuit may be a third variation rate D2 and the driving current variation rate DCR of the pixel circuit PX may be a fourth variation rate B2. A magnitude of the fourth variation rate B2 may be less than a magnitude of the third variation rate D2. For example, the third variation rate D2 may be about 2.45% and the fourth variation rate B2 may be about 0.56%.

When the threshold voltage variation amount TVC of the first transistor T1 is about-0.1V, the driving current variation rate DCR of the related art pixel circuit may be a fifth variation rate D3 and the driving current variation rate DCR of the pixel circuit PX may be a sixth variation rate B3. A magnitude of the sixth variation rate B3 may be less than a magnitude of the fifth variation rate D3. For example, the fifth variation rate D3 may be about-1.37% and the sixth variation rate B3 may be about-0.29%.

When the threshold voltage variation amount TVC of the first transistor T1 is about −0.2V, the driving current variation rate DCR of the related art pixel circuit may be a seventh variation rate D4 and the driving current variation rate DCR of the pixel circuit PX may be an eighth variation rate B4. A magnitude of the eighth variation rate B4 may be less than a magnitude of the seventh variation rate D4. For example, the seventh variation rate D4 may be about −2.80% and the eighth variation rate B4 may be about −0.60%. A magnitude of the driving current variation rate DCR of the related art pixel circuit may be less than a magnitude of the driving current variation rate DCR of the pixel circuit PX. That is, in the first period P1, the fourth node N4 may be initialized to the second initialization voltage VCTRL, which is greater than the reference voltage, by the seventh transistor, which is turned on, such that the driving current variation rate DCR of the pixel circuit PX may decrease. When the driving current variation rate DCR of the pixel circuit PX decreases, the first transistor T1 of the pixel circuit PX may accurately generate the driving current corresponding to the data voltage VDATA regardless of the threshold voltage variation amount TVC of the first transistor T1 of the pixel circuit PX. When the first transistor T1 of the pixel circuit PX accurately generates the driving current corresponding to the data voltage VDATA, the pixel circuit PX may accurately emit light at the target luminance. Accordingly, the display quality of the display device 1 including the pixel circuit PX may be improved.

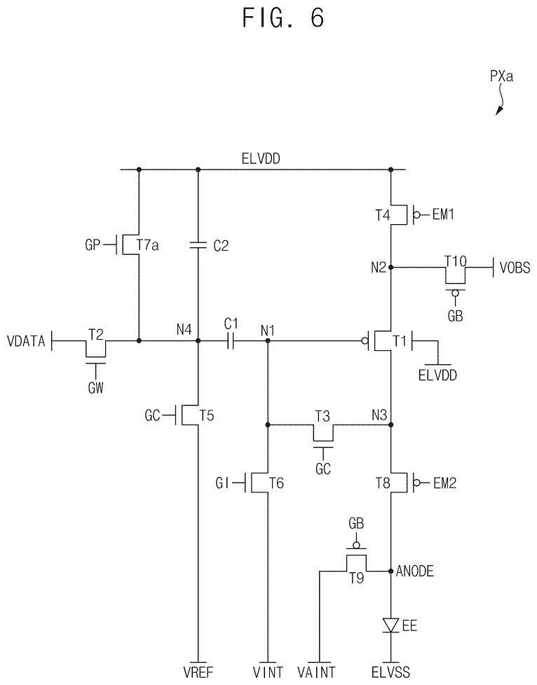

FIG. 6 is a circuit diagram illustrating an embodiment of a pixel circuit PXa included in the display panel 100 of the display device 1 of FIG. 1.

Referring to FIG. 6, the pixel circuit PXa may include the first to seventh transistors T1 to T7a, the first capacitor C1, the second capacitor C2, and the light emitting element EE. In some embodiments, the pixel circuit PXa may further include the eight to tenth transistors T8 to T10.

The pixel circuit PXa of FIG. 6 may be substantially the same as the pixel circuit PX of FIG. 2 except that the second initialization voltage VCTRL is the first driving voltage ELVDD. Thus, the same reference numerals will be used to refer to the same or like parts as those described in the previous embodiment of FIG. 2 and any repetitive explanation concerning the above elements will be omitted.

The seventh transistor T7a may include the control electrode which receives the second initialization gate signal GP, a first electrode which receives the first driving voltage ELVDD, and the second electrode connected to the fourth node N4.

The seventh transistor T7a may be turned on in response to the second initialization gate signal GP having the activation level in the first period P1. The seventh transistor T7a, which is turned on, may transmit the first driving voltage ELVDD to the fourth node N4. The fourth node N4 may have the first driving voltage ELVDD. The fourth node N4 may be initialized to the first driving voltage ELVDD.

The first driving voltage ELVDD may be greater than the reference voltage VREF. That is, the voltage level of the first driving voltage ELVDD may be higher than the voltage level of the reference voltage VREF.

When the fourth node N4 is initialized to the first driving voltage ELVDD, which is greater than the reference voltage VREF, by the seventh transistor T7a, which is turned on, in the first period P1, the compensation rate for the threshold voltage of the first transistor T1 of the pixel circuit PXa may be greater than the compensation rate for the threshold voltage of the first transistor T1 of the related art pixel circuit. That is, the compensation rate of the pixel circuit PXa may increase. The compensation rate of the pixel circuit PXa may increase, such that the first transistor T1 of the pixel circuit PXa may accurately generate the driving current corresponding to the data voltage VDATA. When the first transistor T1 of the pixel circuit PXa accurately generates the driving current corresponding to the data voltage VDATA, the pixel circuit PXa may accurately emit light at a target luminance. When the pixel circuit PXa accurately emits light at the target luminance, the display quality of the display device 1 may be improved.

In addition, the first initialization gate signal GI of the related art pixel circuit may toggle twice in the signal frame for decreasing the luminance deviation. In addition, the compensation gate signal GC of the related art pixel circuit may toggle twice in the signal frame for decreasing the luminance deviation. On the other hand, the first initialization gate signal GI of the pixel circuit PXa according to an embodiment may toggle once in the signal frame for decreasing the luminance deviation. In addition, the compensation gate signal GC of the pixel circuit PXa may toggle once in the signal frame for decreasing the luminance deviation. As the first initialization gate signal GI of the pixel circuit PXa toggles once and the compensation gate signal GC of the pixel circuit PXa toggles once in the signal frame, power consumption of the display device 1 including the pixel circuit PXa may be less than the power consumption of the display device including the related art pixel circuit. That is, the power consumption of the display device 1 including the pixel circuit PXa may be reduced.

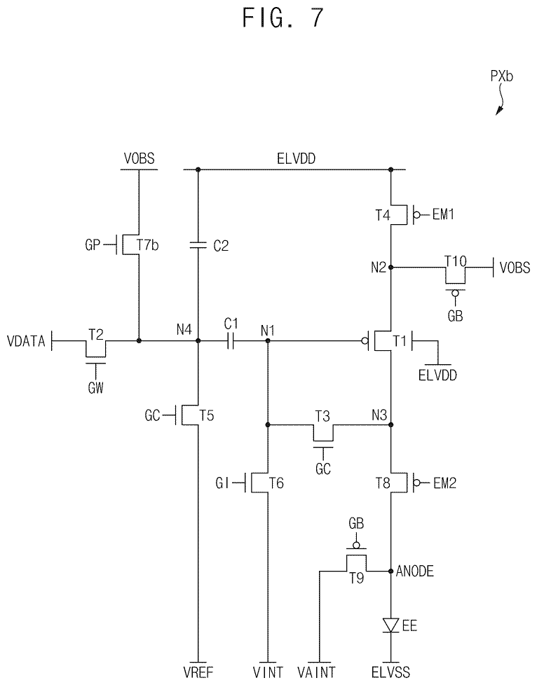

FIG. 7 is a circuit diagram illustrating an embodiment of a pixel circuit PXb included in the display panel 100 of the display device 1 of FIG. 1.

Referring to FIG. 7, the pixel circuit PXb may include the first to seventh transistors T1 to T7b, the first capacitor C1, the second capacitor C2, and the light emitting element EE. In some embodiments, the pixel circuit PXb may further include the eight to tenth transistors T8 to T10.

The pixel circuit PXb of FIG. 7 may be substantially the same as the pixel circuit PX of FIG. 2 except that a first electrode of the seventh transistor T7b receives the bias voltage VOBS. Thus, the same reference numerals will be used to refer to the same or like parts as those described in the previous embodiment of FIG. 2 and any repetitive explanation concerning the above elements will be omitted.

The seventh transistor T7b may include the control electrode which receives the second initialization gate signal GP, the first electrode which receives the bias voltage VOBS, and the second electrode connected to the fourth node N4.

The seventh transistor T7b may be turned on in response to the second initialization gate signal GP having the activation level in the first period P1. The seventh transistor T7b, which is turned on, may transmit the bias voltage VOBS to the fourth node N4. The fourth node N4 may have the bias voltage VOBS. The fourth node N4 may be initialized to the bias voltage VOBS.

The bias voltage VOBS may be greater than the reference voltage VREF. That is, a voltage level of the bias voltage VOBS may be higher than the voltage level of the reference voltage VREF. For example, the bias voltage VOBS may be greater than the first driving voltage ELVDD. That is, the voltage level of the bias voltage VOBS may be higher than the voltage level of the first driving voltage ELVDD.

When the fourth node N4 is initialized to the bias voltage VOBS, which is greater than the reference voltage VREF, by the seventh transistor T7b, which is turned on, in the first period P1, the compensation rate for the threshold voltage of the first transistor T1 of the pixel circuit PXb may be greater than the compensation rate for the threshold voltage of the first transistor T1 of the related art pixel circuit. That is, the compensation rate of the pixel circuit PXb may increase. When the compensation rate of the pixel circuit PXb increases, the first transistor T1 of the pixel circuit PXb may accurately generate the driving current corresponding to the data voltage VDATA. When the first transistor T1 of the pixel circuit PXb accurately generates the driving current corresponding to the data voltage VDATA, the pixel circuit PXb may accurately emit light at the target luminance. When the pixel circuit PXb accurately emits light at the target luminance, the display quality of the display device 1 may be improved.

In addition, the first initialization gate signal GI of the related art pixel circuit may toggle twice in the signal frame for decreasing the luminance deviation. In addition, the compensation gate signal GC of the related art pixel circuit may toggle twice in the signal frame for decreasing the luminance deviation. On the other hand, the first initialization gate signal GI of the pixel circuit PXb according to an embodiment may toggle once in the signal frame for decreasing the luminance deviation. In addition, the compensation gate signal GC of the pixel circuit PXb may toggle once in the signal frame for decreasing the luminance deviation. As the first initialization gate signal GI of the pixel circuit PXb toggles once and the compensation gate signal GC of the pixel circuit PXb toggles once in the signal frame, power consumption of the display device 1 including the pixel circuit PXb may be less than the power consumption of the display device including the related art pixel circuit. That is, the power consumption of the display device 1 including the pixel circuit PXb may be reduced.

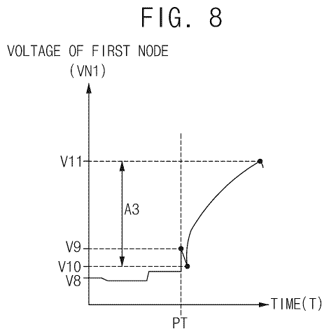

FIG. 8 is a graph illustrating the voltage VN1 of the first node N1 of the pixel circuit PXb of FIG. 7.

The compensation point PT is the point at which the level of the compensation gate signal GC changes from the deactivation level to the activation level. That is, the compensation point PT is the point at which the level of the compensation gate signal GC changes from the low level to the high level.

The compensation rate for the threshold voltage of the first transistor T1 may be calculated by the [Equation], “CR=ΔVGS/ΔVTH”, where CR denotes the compensation rate, ΔVGS denotes the difference between the voltage VN1 of the first node N1 and the voltage of the second node N2, and ΔVTH denotes the threshold voltage variation amount of the first transistor T1.

The voltage of the second node N2 may be constant at the first driving voltage ELVDD, and thus, the compensation rate may be changed according to the variation amount of the voltage VN1 of the first node N1. As the variation amount of the voltage VN1 of the first node N1 increases, the compensation rate may increase.

Referring to FIG. 8, the period before the compensation point PT may be the first period P1. That is, the period before the compensation point PT may be the first initialization period. The period after the compensation point PT may be the second period P2. That is, the period after the compensation point PT may be the threshold voltage compensation period.

In the period before the compensation point PT, the voltage VN1 of the first node N1 of the pixel circuit PXb may be an eight voltage V8. For example, the eight voltage V8 may be the first initialization voltage VINT and the first initialization voltage VINT may be about-3.2V.

In the period before the compensation period, the second initialization gate signal GP may have the activation level, such that the seventh transistor T7b of the pixel circuit PXb may be turned on and the seventh transistor T7b, which is turned on, may transmit the bias voltage VOBS to the fourth node N4 of the pixel circuit PXb. In the period before the compensation period, the fourth node N4 of the pixel circuit PXb may have the bias voltage VOBS. The bias voltage VOBS may be greater than the reference voltage VREF. In addition, the bias voltage VOBS may be greater than the first driving voltage ELVDD. That is, the voltage level of the bias voltage VOBS may be higher than the voltage level of the reference voltage VREF and the voltage level of the bias voltage VOBS may be higher than the voltage level of the first driving voltage ELVDD. For example, the bias voltage VOBS may be about 6.8V.

When the level of the compensation gate signal GC changes from the deactivation level to the activation level at the compensation point PT, the voltage VN1 of the first node N1 of the pixel circuit PXb may be momentarily increased to a ninth voltage V9.

The fifth transistor T5 of the pixel circuit PXb may be turned on in response to the compensation gate signal GC having the activation level and the fifth transistor T5, which is turned on, may transmit the reference voltage VREF to the fourth node N4. The voltage of the fourth node N4 of the pixel circuit PXb may decrease from the bias voltage VOBS to the reference voltage VREF. The voltage of the fourth node N4 of the pixel circuit PXb may decrease to the reference voltage VREF, such that the voltage VN1 of the first node N1 of the pixel circuit PXb may be decreased by the coupling of the first capacitor C1 of the pixel circuit PXb. That is, the voltage VN1 of the first node N1 of the pixel circuit PXb may be decreased from the ninth voltage V9 to a tenth voltage V10.

The bias voltage VOBS may be greater than the first driving voltage ELVDD, such that the voltage VN1 of the first node N1 of the pixel circuit PXb may be decreased more by the coupling of the first capacitor C1 compared to the pixel circuit PX of FIG. 2. Accordingly, a voltage level of the tenth voltage V10 may be lower than a voltage level of the sixth voltage V6.

After the voltage VN1 of the first node N1 of the pixel circuit PXb decreases to the tenth voltage V10 by the coupling of the first capacitor C1 of the pixel circuit PXb, the threshold voltage of the first transistor T1 of the pixel circuit PXb may be compensated by the third transistor T3 of the pixel circuit PXb. The threshold voltage of the first transistor T1 of the pixel circuit PXb may be compensated, such that the voltage VN1 of the first node N1 of the pixel circuit PXb may be increased from the tenth voltage V10 to an eleventh voltage V11. A variation amount of the voltage VN1 of the first node N1 of the pixel circuit PXb due to the threshold voltage compensation operation for the first transistor T1 of the pixel circuit PXb may be a third compensation value A3. The third compensation value A3 may be greater than the second compensation value A2 of FIG. 4B. For example, when the variation amount of the voltage VN1 of the first node N1 is the third compensation value A3, the compensation rate for the threshold voltage of the first transistor T1 of the pixel circuit PXb may be about 99.3%.

For example, as the second initialization voltage VCTRL increases, the variation amount of the voltage VN1 of the first node N1 may increase. That is, as the voltage level of the second initialization voltage VCTRL is higher, the variation amount of the voltage VN1 of the first node N1 may increase. The variation amount of the voltage VN1 of the first node N1 may increase, such that the compensation rate may increase as the second initialization voltage VCTRL increases.

When the fourth node N4 is initialized to the bias voltage VOBS, which is greater than the reference voltage VREF, by the seventh transistor T7b, which is turned on, in the first period P1, the compensation rate for the threshold voltage of the first transistor T1 of the pixel circuit PXb may be greater than the compensation rate for the threshold voltage of the first transistor T1 of the related art pixel circuit. That is, the compensation rate of the pixel circuit PXb may increase. The compensation rate of the pixel circuit PXb may increase, such that the first transistor T1 of the pixel circuit PXb may accurately generate the driving current corresponding to the data voltage VDATA. When the first transistor T1 of the pixel circuit PXb accurately generates the driving current corresponding to the data voltage VDATA, the pixel circuit PXb may accurately emit light at a target luminance. When the pixel circuit PXb accurately emits light at the target luminance, the display quality of the display device 1 may be improved.

In addition, the first initialization gate signal GI of the related art pixel circuit may toggle twice in the signal frame for decreasing a luminance deviation. In addition, the compensation gate signal GC of the related art pixel circuit may toggle twice in the signal frame for decreasing the luminance deviation. The first initialization gate signal GI of the pixel circuit PXb according to an example embodiment may toggle once in the signal frame for decreasing the luminance deviation. In addition, the compensation gate signal GC of the pixel circuit PXb may toggle once in the signal frame for decreasing the luminance deviation. As the first initialization gate signal GI of the pixel circuit PXb toggles once and the compensation gate signal GC of the pixel circuit PXb toggles once in the signal frame, the power consumption of the display device 1 including the pixel circuit PXb may be less than the power consumption of the display device including the related art pixel circuit. That is, the power consumption of the display device 1 including the pixel circuit PXb may be reduced.

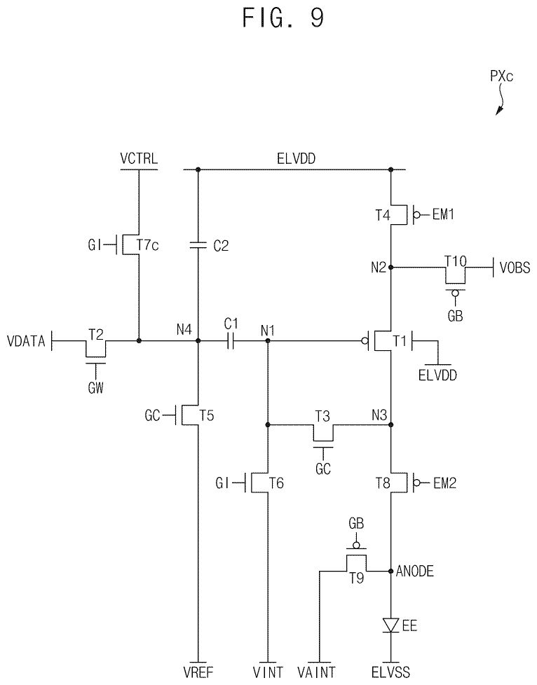

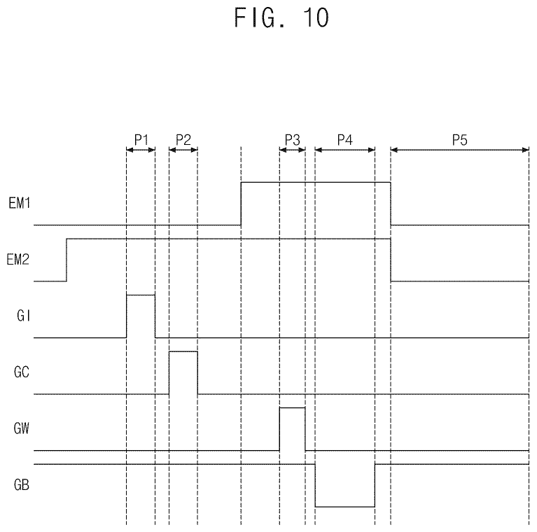

FIG. 9 is a circuit diagram illustrating an embodiment of a pixel circuit PXc in the display panel 100 of the display device 1 of FIG. 1. FIG. 10 is a timing diagram illustrating periods in which the pixel circuit PXc of FIG. 9 operates.

Referring to FIGS. 9 and 10, the pixel circuit PXc may include the first to seventh transistors T1 to T7c, the first capacitor C1, the second capacitor C2, and the light emitting element EE. In some embodiments, the pixel circuit PXc may further include the eight to tenth transistors T8 to T10.

In addition, the periods in which the pixel circuit PXc operates may include first to fifth periods P1 to P5. The first period P1 may be referred to as the first initialization period, the second period P2 may be referred to as the threshold voltage compensation period, the third period P3 may be referred to as the data writing period, a fourth period P4 may be referred to as the second initialization period, and the fifth period P5 may be referred to as the emission period.

The pixel circuit PXc of FIG. 9 may be substantially the same as the pixel circuit PX of FIG. 2 except that a control electrode of the seventh transistor T7c receives the first initialization gate signal GI, and the timing diagram of FIG. 10 may be substantially the same as the timing diagram of FIG. 3 except that the second initialization gate signal GP is the first initialization gate signal GI. Thus, the same reference numerals will be used to refer to the same or like parts as those described in the previous embodiment of FIG. 2 and FIG. 3 and any repetitive explanation concerning the above elements will be omitted.

The second initialization gate signal GP may be equal to the first initialization gate signal GI. That is, the second initialization gate signal GP may be the first initialization gate signal GI.

In a single frame, a level of the second initialization gate signal GP of FIG. 3 may be equal to a level of the first initialization gate signal GI of FIG. 3. Accordingly, when the control electrode of the seventh transistor T7c receives the first initialization gate signal GI, an operation of the pixel circuit PXc of FIG. 9 may be the same as an operation of the pixel circuit PX of FIG. 2.

The seventh transistor T7c may include the control electrode which receives the first initialization gate signal GI, the first electrode which receives the second initialization voltage VCTRL, and the second electrode connected to the fourth node N4.

In the first period P1, the seventh transistor T7c may be turned on in response to the first initialization gate signal GI having the activation level. In the second period P2, the seventh transistor T7c may be turned off in response to the first initialization gate signal GI having the deactivation level. In the third period P3, the seventh transistor T7c may be turned off in response to the first initialization gate signal GI having the deactivation level. In the fourth period P4, the seventh transistor T7c may be turned off in response to the first initialization gate signal GI having the deactivation level. In the fifth period P5, the seventh transistor T7c may be turned off in response to the first initialization gate signal GI having the deactivation level.

When the fourth node N4 is initialized to the second initialization voltage VCTRL, which is greater than the reference voltage VREF, by the seventh transistor T7c, which is turned on, in the first period P1, the compensation rate for the threshold voltage of the first transistor T1 of the pixel circuit PXc may be greater than the compensation rate for the threshold voltage of the first transistor T1 of the related art pixel circuit. That is, the compensation rate of the pixel circuit PXc may increase. The compensation rate of the pixel circuit PXc may increase, such that the first transistor T1 of the pixel circuit PXc may accurately generate the driving current corresponding to the data voltage VDATA. When the first transistor T1 of the pixel circuit PXc accurately generates the driving current corresponding to the data voltage VDATA, the pixel circuit PXc may accurately emit light at the target luminance. When the pixel circuit PXc accurately emits light at the target luminance, the display quality of the display device 1 may be improved.

In addition, the first initialization gate signal GI of the related art pixel circuit may toggle twice in the signal frame for decreasing the luminance deviation. In addition, the compensation gate signal GC of the related art pixel circuit may toggle twice in the signal frame for decreasing the luminance deviation. The first initialization gate signal GI of the pixel circuit PXc according to an example embodiment may toggle once in the signal frame for decreasing the luminance deviation. In addition, the compensation gate signal GC of the pixel circuit PXc may toggle once in the signal frame for decreasing the luminance deviation. As the first initialization gate signal GI of the pixel circuit PXc toggles once and the compensation gate signal GC of the pixel circuit PXc toggles once in the signal frame, power consumption of the display device 1 including the pixel circuit PXc may be less than the power consumption of the display device including the related art pixel circuit. That is, the power consumption of the display device 1 including the pixel circuit PXc may be reduced.

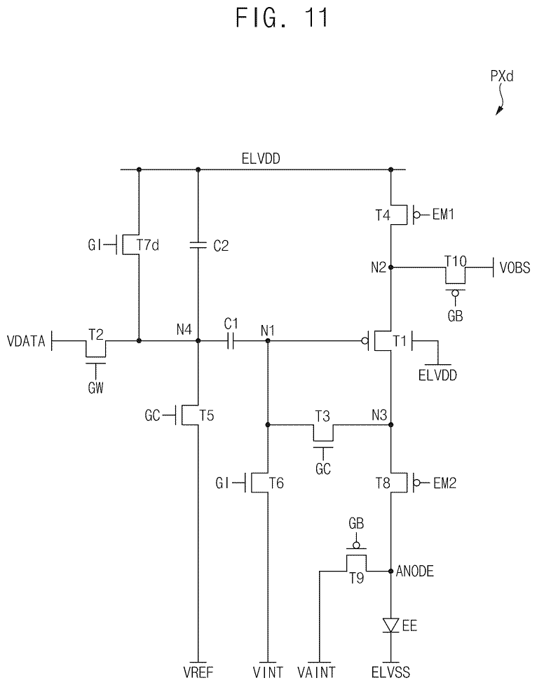

FIG. 11 is a circuit diagram illustrating an embodiment of a pixel circuit PXd included in the display panel 100 of the display device 1 of FIG. 1.

Referring to FIG. 11, the pixel circuit PXd may include the first to seventh transistors T1 to T7d, the first capacitor C1, the second capacitor C2, and the light emitting element EE. In some embodiments, the pixel circuit PXd may further include the eight to tenth transistors T8 to T10.

The pixel circuit PXd of FIG. 11 may be substantially the same as the pixel circuit PXa of FIG. 6 except that a control electrode of the seventh transistor T7d receives the first initialization gate signal GI. Thus, the same reference numerals will be used to refer to the same or like parts as those described in the previous embodiment of FIG. 6 and any repetitive explanation concerning the above elements will be omitted.

The second initialization gate signal GP may be equal to the first initialization gate signal GI. That is, the second initialization gate signal GP may be the first initialization gate signal GI.

In the single frame, the level of the second initialization gate signal GP of FIG. 3 may be equal to the level of the first initialization gate signal GI of FIG. 3. Accordingly, when the control electrode of the seventh transistor T7d receives the first initialization gate signal GI, an operation of the pixel circuit PXd of FIG. 11 may be the same as an operation of the pixel circuit PXa of FIG. 6.

The seventh transistor T7d may include the control electrode which receives the first initialization gate signal GI, the first electrode which receives the first driving voltage ELVDD, and the second electrode connected to the fourth node N4.

When the fourth node N4 is initialized to the first driving voltage ELVDD, which is greater than the reference voltage VREF, by the seventh transistor T7d, which is turned on, in the first period P1, the compensation rate for the threshold voltage of the first transistor T1 of the pixel circuit PXd may be greater than the compensation rate for the threshold voltage of the first transistor T1 of the related art pixel circuit. That is, the compensation rate of the pixel circuit PXd may increase. The compensation rate of the pixel circuit PXd may increase, such that the first transistor T1 of the pixel circuit PXd may accurately generate the driving current corresponding to the data voltage VDATA. When the first transistor T1 of the pixel circuit PXd accurately generates the driving current corresponding to the data voltage VDATA, the pixel circuit PXd may accurately emit light at the target luminance. When the pixel circuit PXd accurately emits light at the target luminance, the display quality of the display device 1 may be improved.

In addition, the first initialization gate signal GI of the related art pixel circuit may toggle twice in the signal frame for decreasing the luminance deviation. In addition, the compensation gate signal GC of the related art pixel circuit may toggle twice in the signal frame for decreasing the luminance deviation. The first initialization gate signal GI of the pixel circuit PXd according to an embodiment may toggle once in the signal frame for decreasing the luminance deviation. In addition, the compensation gate signal GC of the pixel circuit PXd may toggle once in the signal frame for decreasing the luminance deviation. As the first initialization gate signal GI of the pixel circuit PXd toggles once and the compensation gate signal GC of the pixel circuit PXd toggles once in the signal frame, power consumption of the display device 1 including the pixel circuit PXd may be less than the power consumption of the display device including the related art pixel circuit. That is, the power consumption of the display device 1 including the pixel circuit PXd may be reduced.

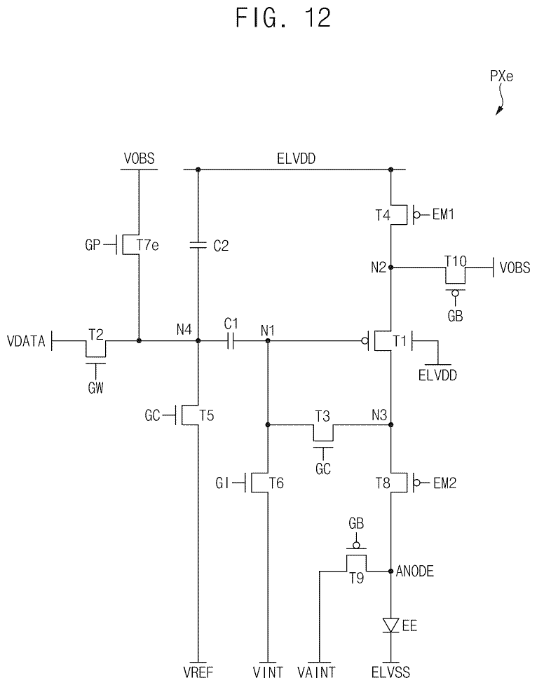

FIG. 12 is a circuit diagram illustrating an embodiment of a pixel circuit PXe included in the display panel 100 of the display device 1 of FIG. 1.

Referring to FIG. 12, the pixel circuit PXe may include the first to seventh transistors T1 to T7e, the first capacitor C1, the second capacitor C2, and the light emitting element EE. In some embodiments, the pixel circuit PXe may further include the eight to tenth transistors T8 to T10.

The pixel circuit PXe of FIG. 12 may be substantially the same as the pixel circuit PXb of FIG. 7 except that a control electrode of the seventh transistor T7e receives the first initialization gate signal GI. Thus, the same reference numerals will be used to refer to the same or like parts as those described in the previous embodiment of FIG. 7 and any repetitive explanation concerning the above elements will be omitted.

The second initialization gate signal GP may be equal to the first initialization gate signal GI. That is, the second initialization gate signal GP may be the first initialization gate signal GI.

In the single frame, the level of the second initialization gate signal GP of FIG. 3 may be equal to the level of the first initialization gate signal GI of FIG. 3. Accordingly, when the control electrode of the seventh transistor T7e receives the first initialization gate signal GI, an operation of the pixel circuit PXe of FIG. 12 may be the same as an operation of the pixel circuit PXb of FIG. 7.

The seventh transistor T7e may include the control electrode which receives the first initialization gate signal GI, the first electrode which receives the bias voltage VOBS, and the second electrode connected to the fourth node N4.

When the fourth node N4 is initialized to the bias voltage VOBS, which is greater than the reference voltage VREF, by the seventh transistor T7e, which is turned on, in the first period P1, the compensation rate for the threshold voltage of the first transistor T1 of the pixel circuit PXe may be greater than the compensation rate for the threshold voltage of the first transistor T1 of the related art pixel circuit. That is, the compensation rate of the pixel circuit PXe may increase. The compensation rate of the pixel circuit PXe may increase, such that the first transistor T1 of the pixel circuit PXe may accurately generate the driving current corresponding to the data voltage VDATA. When the first transistor T1 of the pixel circuit PXe accurately generates the driving current corresponding to the data voltage VDATA, the pixel circuit PXe may accurately emit light at the target luminance. When the pixel circuit PXe accurately emits light at the target luminance, the display quality of the display device 1 may be improved.

In addition, the first initialization gate signal GI of the related art pixel circuit may toggle twice in the signal frame for decreasing the luminance deviation. In addition, the compensation gate signal GC of the related art pixel circuit may toggle twice in the signal frame for decreasing the luminance deviation. The first initialization gate signal GI of the pixel circuit PXe according to an example embodiment may toggle once in the signal frame for decreasing the luminance deviation. In addition, the compensation gate signal GC of the pixel circuit PXe may toggle once in the signal frame for decreasing the luminance deviation. When the first initialization gate signal GI of the pixel circuit PXe toggles once and the compensation gate signal GC of the pixel circuit PXe toggles once in the signal frame, power consumption of the display device 1 including the pixel circuit PXe may be less than the power consumption of the display device including the related art pixel circuit. That is, the power consumption of the display device 1 including the pixel circuit PXe may be reduced.

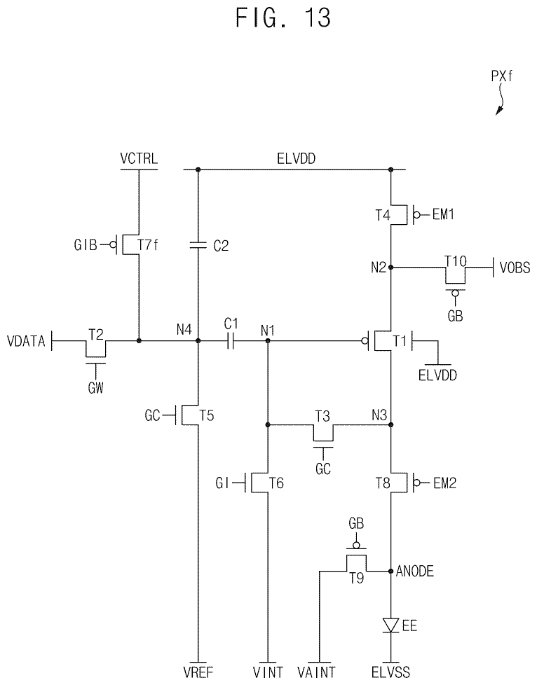

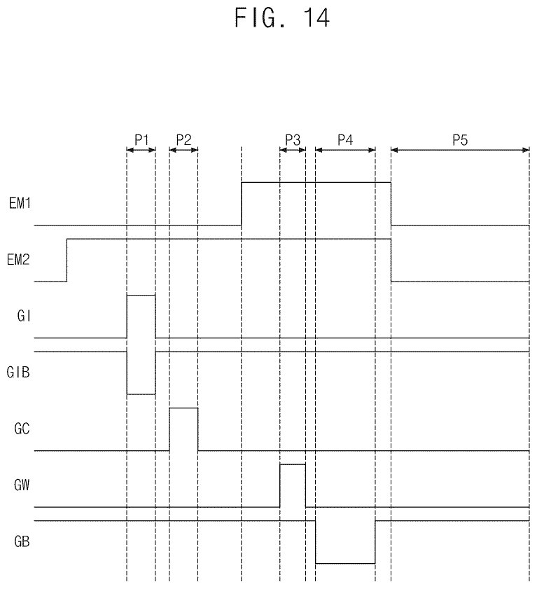

FIG. 13 is a circuit diagram illustrating an embodiment of a pixel circuit PXf included in the display panel 100 of the display device 1 of FIG. 1. FIG. 14 is a timing diagram illustrating periods in which the pixel circuit PXf of FIG. 13 operates.

Referring to FIGS. 13 and 14, the pixel circuit PXf may include the first to seventh transistors T1 to T7f, the first capacitor C1, the second capacitor C2, and the light emitting element EE. In some embodiments, the pixel circuit PXf may further include the eight to tenth transistors T8 to T10.

In addition, the periods in which the pixel circuit PXf operates may include first to fifth periods P1 to P5. The first period P1 may be referred to as the first initialization period, the second period P2 may be referred to as the threshold voltage compensation period, the third period P3 may be referred to as the data writing period, a fourth period P4 may be referred to as the second initialization period, and the fifth period P5 may be referred to as the emission period.

The pixel circuit PXf of FIG. 13 may be substantially the same as the pixel circuit PX of FIG. 2 except that a control electrode of the seventh transistor T7f receives a third initialization gate signal GIB and the timing diagram of FIG. 14 may be substantially the same as the timing diagram of FIG. 3 except for the second initialization gate signal GP. Thus, the same reference numerals will be used to refer to the same or like parts as those described in the previous embodiment of FIG. 2 and FIG. 3 and any repetitive explanation concerning the above elements will be omitted.

The seventh transistor T7f may be implemented as the PMOS transistor. For example, the seventh transistor T7f may be the LTPS transistor. For example, the seventh transistor T7f may be the LTPS thin film transistor.

The seventh transistor T7f may include the control electrode which receives the third initialization gate signal GIB, the first electrode which receives the second initialization voltage VCTRL, and the second electrode connected to the fourth node N4.

A phase of the third initialization gate signal GIB may be opposite to a phase of the first initialization gate signal GI.

In the first period P1, the third initialization gate signal GIB ma have an activation level (e.g., a low level). In the second to fifth periods P2 to P5, the third initialization gate signal GIB ma have a deactivation level (e.g., a high level).

The seventh transistor T7 of FIG. 2 may be implemented as the NMOS transistor and the seventh transistor T7f of FIG. 13 may be implemented as the PMOS transistor, and an operation of the pixel circuit PXf of FIG. 13 when the control electrode of the seventh transistor T7f receives the third initialization gate signal GI may be the same as the operation of the pixel circuit PX of FIG. 2.

In the first period P1, the seventh transistor T7f may be turned on in response to the third initialization gate signal GIB having the activation level. In the second period P2, the seventh transistor T7f may be turned off in response to the third initialization gate signal GIB having the deactivation level. In the third period P3, the seventh transistor T7f may be turned off in response to the third initialization gate signal GIB having the deactivation level. In the fourth period P4, the seventh transistor T7f may be turned off in response to the third initialization gate signal GIB having the deactivation level. In the fifth period P5, the seventh transistor T7f may be turned off in response to the third initialization gate signal GIB having the deactivation level.

When the fourth node N4 is initialized to the second initialization voltage VCTRL, which is greater than the reference voltage VREF, by the seventh transistor T7f, which is turned on, in the first period P1, the compensation rate for the threshold voltage of the first transistor T1 of the pixel circuit PXf may be greater than the compensation rate for the threshold voltage of the first transistor T1 of the related art pixel circuit. That is, the compensation rate of the pixel circuit PXf may increase. The compensation rate of the pixel circuit PXf may increase, such that the first transistor T1 of the pixel circuit PXf may accurately generate the driving current corresponding to the data voltage VDATA. When the first transistor T1 of the pixel circuit PXf accurately generates the driving current corresponding to the data voltage VDATA, the pixel circuit PXf may accurately emit light at the target luminance. When the pixel circuit PXf accurately emits light at the target luminance, the display quality of the display device 1 may be improved.

In addition, the first initialization gate signal GI of the related art pixel circuit may toggle twice in the signal frame for decreasing the luminance deviation. In addition, the compensation gate signal GC of the related art pixel circuit may toggle twice in the signal frame for decreasing the luminance deviation. The first initialization gate signal GI of the pixel circuit PXf may toggle once in the signal frame for decreasing the luminance deviation. In addition, the compensation gate signal GC of the pixel circuit PXf may toggle once in the signal frame for decreasing the luminance deviation. As the first initialization gate signal GI of the pixel circuit PXf toggles once and the compensation gate signal GC of the pixel circuit PXf toggles once in the signal frame, power consumption of the display device 1 including the pixel circuit PXf may be less than the power consumption of the display device including the related art pixel circuit. That is, the power consumption of the display device 1 including the pixel circuit PXf may be reduced.

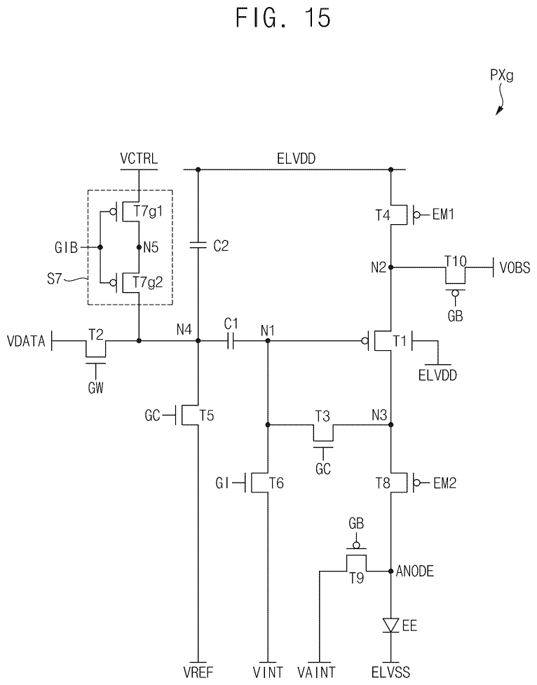

FIG. 15 is a circuit diagram illustrating an embodiment of a pixel circuit PXg included in the display panel 100 of the display device 1 of FIG. 1.

Referring to FIG. 15, the pixel circuit PXg may include the first to sixth transistors T1 to T6, a seventh-first transistor T7g1, a seventh-second transistor T7g2, the first capacitor C1, the second capacitor C2, and the light emitting element EE. In some embodiments, the pixel circuit PXg may further include the eight to tenth transistors T8 to T10.

The pixel circuit PXg of FIG. 15 may be substantially the same as the pixel circuit PXf of FIG. 13 except that the seventh transistor TT7f of FIG. 13 is replaced with a switching element S7 of FIG. 15. Thus, the same reference numerals will be used to refer to the same or like parts as those described in the previous embodiment of FIG. 13 and any repetitive explanation concerning the above elements will be omitted.

The switching element S7 may include the seventh-first transistor T7g1 and the seventh-second transistor T7g2.

The seventh-first transistor T7g1 may include a control electrode which receives the third initialization gate signal GIB, a first electrode which receives the second initialization voltage VCTRL, and a second electrode connected to a fifth node N5.

The seventh-second transistor T7g2 may include a control electrode which receives the third initialization gate signal GIB, a first electrode connected to the fifth node N5, and a second electrode connected to the fourth node N4.

Each of the seventh-first transistor T7g1 and the seventh-second transistor T7g2 may be implemented as the PMOS transistor. For example, each of the seventh-first transistor T7g1 and the seventh-second transistor T7g2 may be the LTPS transistor. For example, each of the seventh-first transistor T7g1 and the seventh-second transistor T7g2 may be the LTPS thin film transistor.

The switching element S7 including the seventh-first transistor T7g1 and the seventh-second transistor T7g2 may be referred to as a dual transistor.

As the seventh-first transistor T7g1 and the seventh-second transistor T7g2 are connected in series, a leakage current of the switching element S7 may decrease.

Each of the seventh-first transistor T7g1 of FIG. 15 and the seventh-second transistor T7g2 of FIG. 15 may be implemented as the PMOS transistor, the control electrode of the seventh-first transistor T7g1 of FIG. 15 may receive the third initialization gate signal GIB, and the control electrode of the seventh-second transistor T7g2 of FIG. 15 may receive the third initialization gate signal GIB, and an operation of the pixel circuit PXg of FIG. 15 when the switching element S7 of FIG. 15 receives the third initialization gate signal GIB may be the same as the operation of the pixel circuit PXf of FIG. 13.

In the first period P1, the switching element S7 may be turned on in response to the third initialization gate signal GIB having the activation level.

In the second to fifth periods P2 to P5, the switching element S7 may be turned off in response to the third initialization gate signal GIB having the deactivation level.

That is, in the first period P1, the seventh-first transistor T7g1 may be turned on in response to the third initialization gate signal GIB having the activation level and the seventh-second transistor T7g2 may be turned on in response to the third initialization gate signal GIB having the activation level.

In the first period P1, the seventh-first transistor T7g1, which is turned on, may transmit the second initialization voltage VCTRL to the first electrode of the seventh-second transistor T7g2. In addition, in the first period P1, the seventh-second transistor T7g2, which is turned on, may transmit the second initialization voltage VCTRL, which is received from the seventh-first transistor T7g1, to the fourth node N4. Accordingly, in the first period P1, the fourth node N4 may be initialized to the second initialization voltage VCTRL.

In the second period P2, the seventh-first transistor T7g1 may be turned off in response to the third initialization gate signal GIB having the deactivation level and the seventh-second transistor T7g2 may be turned off in response to the third initialization gate signal GIB having the deactivation level.

In the third period P3, the seventh-first transistor T7g1 may be turned off in response to the third initialization gate signal GIB having the deactivation level and the seventh-second transistor T7g2 may be turned off in response to the third initialization gate signal GIB having the deactivation level.

In the fourth period P4, the seventh-first transistor T7g1 may be turned off in response to the third initialization gate signal GIB having the deactivation level and the seventh-second transistor T7g2 may be turned off in response to the third initialization gate signal GIB having the deactivation level.

In the fifth period P5, the seventh-first transistor T7g1 may be turned off in response to the third initialization gate signal GIB having the deactivation level and the seventh-second transistor T7g2 may be turned off in response to the third initialization gate signal GIB having the deactivation level.

When the fourth node N4 is initialized to the second initialization voltage VCTRL, which is greater than the reference voltage VREF, by the seventh-first transistor T7g1, which is turned on, and the seventh-second transistor T7g2, which is turned on, in the first period P1, the compensation rate for the threshold voltage of the first transistor T1 of the pixel circuit PXg may be greater than the compensation rate for the threshold voltage of the first transistor T1 of the related art pixel circuit. That is, the compensation rate of the pixel circuit PXg may increase. The compensation rate of the pixel circuit PXg may increase, such that the first transistor T1 of the pixel circuit PXg may accurately generate the driving current corresponding to the data voltage VDATA. When the first transistor T1 of the pixel circuit PXg accurately generates the driving current corresponding to the data voltage VDATA, the pixel circuit PXg may accurately emit light at the target luminance. When the pixel circuit PXg accurately emits light at the target luminance, the display quality of the display device 1 may be improved.

In addition, the first initialization gate signal GI of the related art pixel circuit may toggle twice in the signal frame for decreasing the luminance deviation. In addition, the compensation gate signal GC of the related art pixel circuit may toggle twice in the signal frame for decreasing the luminance deviation. The first initialization gate signal GI of the pixel circuit PXg according to an example embodiment may toggle once in the signal frame for decreasing the luminance deviation. In addition, the compensation gate signal GC of the pixel circuit PXg may toggle once in the signal frame for decreasing the luminance deviation. When the first initialization gate signal GI of the pixel circuit PXg toggles once and the compensation gate signal GC of the pixel circuit PXg toggles once in the signal frame, power consumption of the display device 1 including the pixel circuit PXg may be less than the power consumption of the display device including the related art pixel circuit. That is, the power consumption of the display device 1 including the pixel circuit PXg may be reduced.

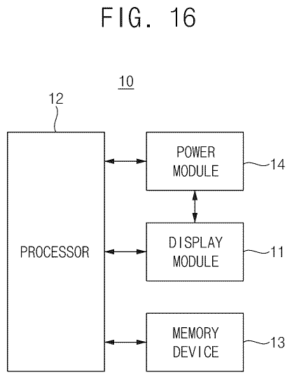

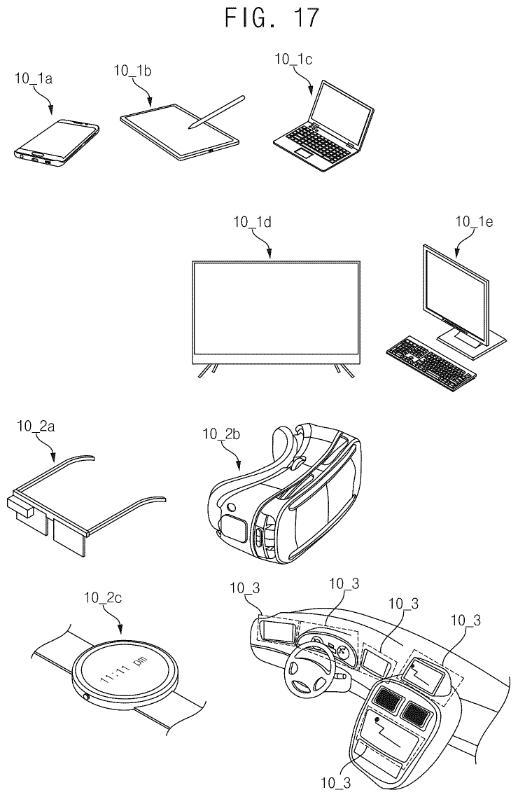

FIG. 16 is a block diagram illustrating an electronic device 10 according to one or more embodiments. FIG. 17 is a schematic diagram illustrating various examples of the electronic device 10 of FIG. 1.

Referring to FIG. 16, the electronic device 10 may include a display module (or display device) 11, a processor 12, a memory device 13, and a power module (e.g., power circuitry) 14.

The display device 1 of FIG. 1 may be applied to various electronic devices. In an embodiment, the electronic device 10 may include the display device 1 of FIG. 1. That is, an operation of the display device 1 included in the electronic device 10 may be the same as an operation of the display device 1 described with reference FIGS. 1 to 15. In an embodiment, the electronic device 10 may further include modules or devices having other additional functions in addition to the display device 1.

The processor 12 may include, for example but not limited to, at least one of a central processing unit (CPU), an application processor (AP), a graphic processing unit (GPU), a communication processor (CP), an image signal processor (ISP), and a controller. The processor 12 may include one or more processors.

In an embodiment, the processor 12 may generate the input control signal CONT of FIG. 1 and the input image data IMG of FIG. 1 and may provide the input control signal CONT of FIG. 1 and the input image data IMG of FIG. 1 to the driving controller 200 included in the display device 1 of FIG. 1.

In an embodiment, the processor 12 may be provided as two or more forms in terms of functionality or structure. For example, the processor 12 may include a main processor in the form of a first driving chip including the central processing unit and an auxiliary processor in the form of a second driving chip including the controller that receives an image signal from the main processor and processes the image signal to conform interface specifications of the display module 11. The auxiliary processor may include the driving controller 200 included in the display device 1 of FIG. 1. Accordingly, the main processor may provide the input control signal CONT of FIG. 1 and the input image data IMG of FIG. 1 to the auxiliary processor. The auxiliary processor may process the image signal based on the input control signal CONT and the input image data IMG.

The memory device 13 may include at least one of a non-volatile memory device and a volatile memory device. Data information for an operation of the display module 11 or the processor 12 may be stored in the memory device 13. When the processor 12 executes an application stored in the memory device 13, the input control signal CONT and/or the input image data IMG may be transmitted to the display module 11. The display module 11 may process the input control signal CONT and/or the input image data IMG provided from the processor 12 and may output image information through the display panel. The display module 11 may include, for example but not limited to, organic light emitting diodes, quantum-dot organic light emitting diodes, micro-light-emitting diodes, nano-light-emitting diodes, liquid crystals, and/or the like.

The power module 13 may include a power supply module, such as a power adapter or a battery device, and a power conversion module that converts power supplied by the power supply module and generates power required for the operation of the electronic device 10.

At least one of the components of the electronic device 10 may be included in the display device 1. In addition, some of individual modules functionally included in one module may be included in the display device 1 and others may be provided separately from the display device 1. For example, the display device 1 may include the display module 11, and the processor 12, the memory device 13, and the power module 14 may be provided in the form of other devices in the electronic device 10, other than the display device 1.

Referring to FIG. 17, various electronic devices having the display device 1 may include an image display electronic device such as a smart phone 10_1a, a tablet PC 10_1b, a laptop computer 10_1c, a TV 10_1d, a desk monitor 10_1e, and the like. In addition, the various electronic devices may include a wearable electronic device including the display module such as smart glasses 10_2a, a head mounted display 10_2b, a smart watch 10_2c, and the like. In addition, the various electronic device may include a vehicle electronic device 10_3 including the display module, such as an instrument panel, a center fascia, a center information display (CID) on a dashboard, a room mirror display, and the like. The electronic device 10 is not limited to the image display electronic device, the wearable electronic device and the vehicle electronic device 10_3.

The present disclosures may be applied to a display device and an electronic device including the display device. For example, the present disclosures may be applied to a television (TV), a digital TV, a 3D TV, a mobile phone, a smart phone, a tablet computer, a laptop computer, a personal computer (PC), a household electronic device, a personal digital assistant (PDA), a portable multimedia player (PMP), a digital camera, a music player, a portable game console, a navigation device, etc.

According to one or more example embodiments of the present disclosure, the seventh transistor of the pixel circuit may initialize a voltage of the fourth node to the second initialization voltage which is greater than the reference voltage in a first initialization period, and thus, a compensation rate for a threshold voltage of the first transistor of the pixel circuit may increase. The compensation rate for the threshold voltage of the first transistor included in the pixel circuit may increase such that a driving current variation rate according to a threshold voltage variation amount of the first transistor may decrease. The driving current variation rate may decrease such that the first transistor may accurately generate a driving current corresponding to the data voltage regardless of the threshold voltage of the first transistor. The first transistor may accurately generate the driving current corresponding to the data voltage such that the pixel circuit may accurately emit light at a target luminance corresponding to the data voltage. The pixel circuit may accurately emit light at the target luminance such that display quality of the display device included in the pixel circuit may be improved.

At least one of the components, elements, modules or units (collectively “components” in this paragraph) represented by a block or an equivalent indication in the drawings may be implemented or embodied by analog and/or digital circuits including one or more of a logic gate, an integrated circuit, a microprocessor, a microcontroller, a memory circuit, a passive electronic component, an active electronic component, an optical component, and the like. Alternatively or additionally, these components may be implemented or embodied by software including one or more instructions stored in an internal or external storage medium that is readable by at least one processor. For example, the at least one processor may invoke at least one of the one or more instructions stored in the storage medium, and execute it, with or without using one or more other components under the control of the at least one processor. This allows the at least one processor to perform at least one function or operation described above as being performed by each of the components according to the at least one instruction invoked. Here, the at least one processor may include a central processing unit, a graphic processing unit, another type of microprocessor, not being limited thereto.

The foregoing is illustrative of the present disclosure and is not to be construed as limiting thereof. Although a few embodiments of the present disclosure have been described, those skilled in the art will readily appreciate that many modifications are possible in the embodiments without materially departing from the novel teachings and advantages of the present disclosure. Accordingly, all such modifications are intended to be included within the scope of the present disclosure as defined in the claims. In the claims, means-plus-function clauses are intended to cover the structures described herein as performing the recited function and not only structural equivalents but also equivalent structures. Therefore, it is to be understood that the foregoing is illustrative of the present disclosure and is not to be construed as limited to the specific embodiments disclosed, and that modifications to the disclosed embodiments, as well as other embodiments, are intended to be included within the scope of the appended claims. The present disclosure is defined by the following claims, with equivalents of the claims to be included therein.

What is claimed is:

1. A pixel circuit comprising:
a first transistor comprising a control electrode connected to a first node, a first electrode connected to a second node, and a second electrode connected to a third node;
a second transistor comprising a control electrode configured to receive a writing gate signal, a first electrode configured to receive a data voltage, and a second electrode connected to a fourth node;
a third transistor comprising a control electrode configured to receive a compensation gate signal, a first electrode connected to the first node, and a second electrode connected to the third node;
a fourth transistor comprising a control electrode configured to receive a first emission signal, a first electrode configured to receive a first driving voltage, and a second electrode connected to the second node;
a fifth transistor comprising a control electrode configured to receive the compensation gate signal, a first electrode connected to the fourth node, and a second electrode configured to receive a reference voltage;
a sixth transistor comprising a control electrode configured to receive a first initialization gate signal, a first electrode connected to the first node, and a second electrode configured to receive a first initialization voltage;
a seventh transistor comprising a control electrode configured to receive a second initialization gate signal, a first electrode configured to receive a second initialization voltage, and a second electrode connected to the fourth node;
a first capacitor comprising a first electrode connected to the fourth node and a second electrode connected to the first node;
a second capacitor comprising a first electrode configured to receive the first driving voltage and a second electrode connected to the fourth node; and
a light emitting element comprising an anode and a cathode configured to receive a second driving voltage.

2. The pixel circuit of claim 1, wherein the second initialization gate signal is the same as the first initialization gate signal.

3. The pixel circuit of claim 1, wherein the second initialization voltage is the same as the first driving voltage.

4. The pixel circuit of claim 1, wherein a voltage level of the second initialization voltage is higher than a voltage level of the first driving voltage.

5. The pixel circuit of claim 1, wherein the pixel circuit further comprises an eighth transistor comprising a control electrode configured to receive a second emission signal, a first electrode connected to the third node, and a second electrode connected to the anode of the light emitting element.

6. The pixel circuit of claim 1, wherein the pixel circuit further comprises a ninth transistor comprising a control electrode configured to receive a bias gate signal, a first electrode configured to receive an anode initialization voltage, and a second electrode connected to the anode of the light emitting element.

7. The pixel circuit of claim 1, wherein the pixel circuit further comprises a tenth transistor comprising a control electrode configured to receive a bias gate signal, a first electrode connected to the second node, and a second electrode configured to receive a bias voltage.

8. The pixel circuit of claim 7, wherein the second initialization voltage is the same as the bias voltage.

9. A display device comprising:
a display panel comprising a pixel circuit; and
a display panel driver configured to drive the display panel,
wherein the pixel circuit comprises:
a first transistor comprising a control electrode connected to a first node, a first electrode connected to a second node, and a second electrode connected to a third node;
a second transistor comprising a control electrode configured to receive a writing gate signal, a first electrode configured to receive a data voltage, and a second electrode connected to a fourth node;
a third transistor comprising a control electrode configured to receive a compensation gate signal, a first electrode connected to the first node, and a second electrode connected to the third node;
a fourth transistor comprising a control electrode configured to receive a first emission signal, a first electrode configured to receive a first driving voltage, and a second electrode connected to the second node;
a fifth transistor comprising a control electrode configured to receive the compensation gate signal, a first electrode connected to the fourth node, and a second electrode configured to receive a reference voltage;
a sixth transistor comprising a control electrode configured to receive a first initialization gate signal, a first electrode connected to the first node, and a second electrode configured to receive a first initialization voltage;
a seventh transistor comprising a control electrode configured to receive a second initialization gate signal, a first electrode configured to receive a second initialization voltage, and a second electrode connected to the fourth node;
a first capacitor comprising a first electrode connected to the fourth node and a second electrode connected to the first node;
a second capacitor comprising a first electrode configured to receive the first driving voltage and a second electrode connected to the fourth node; and
a light emitting element comprising an anode and a cathode configured to receive a second driving voltage.

10. The display device of claim 9, wherein the second initialization gate signal is the same as the first initialization gate signal.

11. The display device of claim 9, wherein the second initialization voltage is the same as the first driving voltage.

12. The display device of claim 9, wherein a voltage level of the second initialization voltage is higher than a voltage level of the first driving voltage.

13. The display device of claim 9, wherein the pixel circuit further comprises an eighth transistor comprising a control electrode configured to receive a second emission signal, a first electrode connected to the third node, and a second electrode connected to the anode of the light emitting element.

14. The display device of claim 9, wherein the pixel circuit further comprises a ninth transistor comprising a control electrode configured to receive a bias gate signal, a first electrode configured to receive an anode initialization voltage, and a second electrode connected to the anode of the light emitting element.

15. The display device of claim 9, wherein the pixel circuit further comprises a tenth transistor comprising a control electrode configured to receive a bias gate signal, a first electrode connected to the second node, and a second electrode configured to receive a bias voltage.

16. The display device of claim 15, wherein the second initialization voltage is the same as the bias voltage.

17. An electronic device comprising:
a processor configured to generate an input control signal and input image data;
a display panel comprising a pixel circuit; and
a display panel driver configured to drive the display panel based on the input control signal and the input image data,
wherein the pixel circuit comprises:
a first transistor comprising a control electrode connected to a first node, a first electrode connected to a second node, and a second electrode connected to a third node;
a second transistor comprising a control electrode configured to receive a writing gate signal, a first electrode configured to receive a data voltage, and a second electrode connected to a fourth node;
a third transistor comprising a control electrode configured to receive a compensation gate signal, a first electrode connected to the first node, and a second electrode connected to the third node;
a fourth transistor comprising a control electrode configured to receive a first emission signal, a first electrode configured to receive a first driving voltage, and a second electrode connected to the second node;
a fifth transistor comprising a control electrode configured to receive the compensation gate signal, a first electrode connected to the fourth node, and a second electrode configured to receive a reference voltage;
a sixth transistor comprising a control electrode configured to receive a first initialization gate signal, a first electrode connected to the first node, and a second electrode configured to receive a first initialization voltage;
a seventh transistor comprising a control electrode configured to receive a second initialization gate signal, a first electrode configured to receive a second initialization voltage, and a second electrode connected to the fourth node;
a first capacitor comprising a first electrode connected to the fourth node and a second electrode connected to the first node;
a second capacitor comprising a first electrode configured to receive the first driving voltage and a second electrode connected to the fourth node; and
a light emitting element comprising an anode and a cathode configured to receive a second driving voltage.

18. The electronic device of claim 17, wherein the second initialization gate signal is the same as the first initialization gate signal.

19. The electronic device of claim 17, wherein the second initialization voltage is the same as the first driving voltage.

20. The electronic device of claim 17, wherein a voltage level of the second initialization voltage is higher than a voltage level of the first driving voltage.
